(19) United States
(12) Patent Application Publication
(10) Pub. No.: US 2026/0140871 A1
(43) Pub. Date: May 21, 2026

(54) DATA STORAGE DEVICES WITH DUAL MEMORY SPACES

(71) Applicant: Sandisk Technologies, Inc., Milpitas, CA (US)

(72) Inventors: Ankur Agrawal, Bangalore (IN); Sudhan Immanuel Godwin, Bangalore (IN); Varun Gopal, Bangalore (IN); Vinay Vijay Shetgaonkar, Mapusa (IN)

(21) Appl. No.: 19/205,728

(22) Filed: May 12, 2025

Related U.S. Application Data
(63) Continuation-in-part of application No. 18/954,986, filed on Nov. 21, 2024.

(51) Int. Cl. G06F 12/02

(52) U.S. Cl. CPC G06F 12/0246; G06F 2212/7206

(57) ABSTRACT

A data storage device (DSD) includes two data storage controllers, one controls NAND dies of a first quality grade, such as prime grade, and the other controls NAND dies of a lower quality grade, such as an archival grade. A multiplexer enables a user to switch between the two controllers and their respective NAND dies. In another example, the DSD is a hybrid drive with both a solid state device (SSD) and hard disk drive (HDD). A multiplexer enables a user to switch between the SSD and HDD. In yet another example, the DSD includes a Universal Serial Bus (USB)-C connector configured for concurrent communications over two communication lanes with different communication protocols/speeds. One lane is connected to a first data storage controller. The second lane is connected to a second data storage controller. A communication lane switch enables the user to swap the lane communication protocols.

### CROSS-REFERENCE TO RELATED APPLICATIONS

This application is a continuation-in-part (CIP) of U.S. patent application Ser. No. 18/954,986, filed Nov. 21, 2024, having Attorney Docket No. WDT-1463 (WDA-7797-US), entitled “DATA STORAGE DEVICE WITH DUAL MEMORY SPACES ACCESSIBLE BY A HOST USING DIFFERENT COMMUNICATION PROTOCOLS BASED ON THE MATING ORIENTATION OF A REVERSIBLE CONNECTOR,” the entire contents of which is incorporated herein by reference.

### FIELD

The disclosure relates, in some aspects, to data storage devices such as solid state devices (SSDs) and hard disk drives (HDDs). More specifically, but not exclusively, the disclosure relates to data storage devices with Universal Serial Bus (USB) Type-C connectors.

### INTRODUCTION

In consumer electronics, solid state drives (SSDs) or other data storage devices incorporating non-volatile memories (NVMs) are often replacing or supplementing conventional magnetic storage devices such as hard disk drives (HDDs) for mass storage. The non-volatile memories may include one or more flash memory devices, such as NAND flash memories. The NVMs may also include multiple NAND flash dies or chips that form the NVM. Other data storage devices employ volatile memory such as dynamic random access memory (DRAM). Within SSDs, HDDs, and other data storage devices, it is important to maximize drive capacity without significantly increasing costs or power consumption. Herein, systems, methods and apparatus are provided to that end.

### SUMMARY

The following presents a simplified summary of some aspects of the disclosure to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

One embodiment of the disclosure provides a data storage device that includes: a first data storage controller coupled to a first memory, the first memory comprising one or more memory dies of a first quality grade. data storage device; a second data storage controller coupled to a second memory, the second memory comprising one or more memory dies of a second quality grade that is lower than the first quality grade; a multiplexer coupled to the first data storage controller and the second data storage controller; and a connector coupled to the multiplexer and configured to connect the multiplexer to a host; wherein, based on a memory selection signal, the multiplexer is configured to (a) connect the first data storage controller and the first memory to the host through the multiplexer or (b) connect the second data storage controller and the second memory to the host through the multiplexer.

Another embodiment of the disclosure provides a data storage device that includes: a first data storage controller coupled to a first memory, the first memory comprising NAND; a second data storage controller coupled to a second memory, the second memory comprising a magnetic storage device, such as a hard disk drive (HDD); a multiplexer coupled to the first data storage controller and the second data storage controller; a connector coupled to the multiplexer and configured to connect the multiplexer to a host; wherein, based on a memory selection signal, the multiplexer is configured to (a) connect the first data storage controller and the first memory to the host through the multiplexer or (b) connect the second data storage controller and the second memory to the host through the multiplexer.

Yet another embodiment of the disclosure provides a data storage device that includes: a first data storage controller coupled to a first memory; a second data storage controller coupled to a second memory; a connector configured to connect the data storage device to a host using a first communication lane and a second communication lane, with communications over the first communication lane configured in accordance with a first communication protocol and concurrent communications over the second communication lane configured in accordance with a second, different communication protocol; and a lane control switch configured to (a) connect the first data storage controller to the host via the connector using the first communication lane while the second data storage controller is concurrently connected to the host via the connector using the second communication lane or (b) connect the first data storage controller to the host via the connector using the second communication lane while the second data storage controller is concurrently connected to the host via the connector using the first communication lane. The first communication protocol may be, e.g., USB 10 giga-bits per second (Gbps) or higher and the second communication protocol may be USB 2.0 at 480 mega-bits per second (Mbps).

### BRIEF DESCRIPTION OF THE DRAWINGS

FIG. 1 is a schematic block diagram configuration for an exemplary solid state device (SSD) and USB-C connection port socket, according to the prior art.

FIG. 2A is a schematic diagram of a USB-C socket, according to the prior art.

FIG. 2B is a schematic diagram of a USB-C plug, according to the prior art.

FIG. 3 is a schematic block diagram of an exemplary SSD and USB-C connection port socket, wherein the SSD has dual memory spaces or partitions and dual data storage controllers, with concurrent communication enabled with a host over dual connection lanes with different communication protocols depending upon the USB-C plug/socket mating orientation, in accordance with aspects of the present disclosure.

FIG. 4A is a schematic diagram of an SSD with a USB-C plug/pocket in a first mating orientation that provides access by the host to a first memory partition via the USB 10 Gigabits-per-second (Gbps) communication protocol and to a second memory partition via the USB 2.0 communication protocol, in accordance with aspects of the present disclosure.

FIG. 4B is a schematic diagram of an SSD with the USB-C plug/pocket in a second, opposite mating orientation that provides access by the host to the first memory partition via USB 2.0 and to the second memory partition via a USB 10 Gbps, in accordance with aspects of the present disclosure.

FIGS. 5A and 5B are schematic diagrams of an SSD with a USB-C plug/pocket, illustrating a use case wherein a background backup is performed with the speed of the backup depending upon the mating orientation, in accordance with aspects of the present disclosure.

FIG. 6 is a block diagram of a system including a host, a USB-C connection cable, and an SSD, wherein the SSD has dual memory spaces and dual data storage controllers, and wherein concurrent communication enabled with a host over dual connection lanes with different communication protocols depending upon the USB-C plug/socket mating orientation, in accordance with aspects of the present disclosure.

FIG. 7 is a schematic block diagram configuration for an exemplary apparatus, such as an SSD, configured according to aspects of the present disclosure.

FIG. 8 is a schematic block diagram configuration for an exemplary data storage device configured according to aspects of the present disclosure.

FIG. 9 illustrates an exemplary procedure according to aspects of the present disclosure.

FIG. 10 is a block diagram of a system including a host and an SSD, wherein the SSD has a first memory space with prime grade NAND dies, a second memory space with non-prime grade NAND dies, and a multiplexer/demultiplexer (MUX/DEMUX) for selecting between the two memory spaces, in accordance with aspects of the present disclosure.

FIG. 11 is a flow diagram of a method for use with the system of FIG. 10, in accordance with aspects of the present disclosure.

FIG. 12 is a block diagram of a system including a host and a data storage device (DSD), wherein the DSD has a first memory space with prime grade NAND dies, a second memory space with an HDD, and a MUX/DEMUX for selecting between the two memory spaces, in accordance with aspects of the present disclosure.

FIG. 13 is a flow diagram of a method for use with the system of FIG. 12, in accordance with aspects of the present disclosure.

FIG. 14 is a block diagram of a system including a host and an SSD, wherein the SSD has a first memory space with prime grade NAND dies, a second memory space with non-prime grade NAND dies, and a communication lane switch for selecting between two communication lanes with different communication protocols for coupling the memory spaces to a host, in accordance with aspects of the present disclosure.

FIG. 15 is a flow diagram of a method for use with the system of FIG. 14, in accordance with aspects of the present disclosure.

FIGS. 16A and 16B are perspective views of an external memory drive and a connection line having a reversible connection plug, wherein the drive and the plug have matching indicia, in accordance with aspects of the present disclosure.

FIG. 17 is a schematic block diagram configuration for an exemplary data storage device configured according to further aspects of the present disclosure.

FIG. 18 is another schematic block diagram configuration for an exemplary data storage device configured according to further aspects of the present disclosure.

FIG. 19 is another schematic block diagram configuration for an exemplary data storage device configured according to further aspects of the present disclosure.

### DETAILED DESCRIPTION

In the following detailed description, reference is made to the accompanying drawings, which form a part thereof. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

Some aspects herein relate to portable data storage devices (DSD) having non-volatile memory (NVM), such as solid-state devices (SSDs), e.g., NAND flash memory storage devices (herein “NANDs”). (A NAND is a type of non-volatile storage technology that does not require power to retain data. It exploits negative-AND, i.e., NAND, logic.) To provide a concrete example, a portable SSD having one or more NVM NAND dies will be used below in the description of various embodiments. The SSD may be connected to a host via a flexible connection cable or may be configured as a thumb drive for directly mounting to a host such as a laptop computer or smart phone. It is understood that at least some aspects described herein may be applicable to other forms of SSDs as well. For example, at least some aspects described herein may be applicable to phase-change memory (PCM) arrays, magneto-resistive random access memory (MRAM) arrays, and resistive random access memory (ReRAM) arrays. Features may be implemented within a CMOS direct bonded (CBA) NAND chip or die (wherein CMOS refers to a complementary metal-oxide-semiconductor). Features may also be implemented within 3D XPoint memory cores, ferroelectric random-access memory (FeRAM) cores, and other types of memory cores. In some embodiments, one or more of the memory modules or portions thereof may be configured as other types of storage class memory (SCM).

Generally speaking, the memory modules may include any of a variety of Random Access Memory (RAM), dynamic RAM (DRAM), Read-Only Memory (ROM), Programmable ROM (PROM), Erasable PROM (EPROM), Electrically EPROM (EEPROM), hard disk drives, flash drives, memory tapes, cloud memory, or any combination of primary and/or secondary memory that is suitable for performing the operations described herein.

Additional aspects herein relate to SSDs configured for use with Universal Serial Bus (USB) Type-C(herein “USB-C”) cables and connectors or similar reversible connectors. Notably, USB-C refers to the configuration of cables and connectors (i.e., the connection plugs and sockets). USB-C is not communication protocol. The USB-C connectors have two-fold rotational symmetry enabling a USB-C plug to be inserted into a corresponding USB-C socket (or receptacle) in either of two orientations. That is, the plugs and sockets have a physically symmetric pinout. Electrically, however, USB-C connectors are not symmetric and the two ends of a USB-C cable are electrically different due to the cable wiring. For the user standpoint, USB-C cables often appear symmetric because software within the devices that the cables interconnect are configured to make the plugs, sockets, and cables behave as though symmetric.

Various communication protocols are compatible with USB-C cables, including USB4. Under the USB4 standard, devices must support a data communication bit rate of at least 20 gigabits (Gbit/s or Gbps) (e.g., 10 Gbps for each of two concurrent lanes) and may enable rates of 40 Gbit/s (USB4 version 1.0) and 80 Gbit/s (USB4 version 2.0). USB4 is currently only defined for the USB-C connector. The USB4 standard mandates backwards compatibility to USB 2.0 and USB 3.x. USB 3.2 (aka USB 10 Gbps) provides for (or specifies) 10 Gbps transmission rates. USB 2.0 provides for (or specifies) 480 Mbps. Note that, herein, the USB-C cables used in the various embodiments are “Full-Featured” Type C cables compatible with USB4 and USB 3.x. There are also USB 2.0 Type-C cables compatible with only USB 2.0. Some aspects of the disclosure are also compatible with other (non-USB) reversible connectors, as discussed below.

TABLE I lists current USB standards (versions or protocols) and connectors:

TABLE I

| | | | Original USB | Current USB | USB |
|---|---|---|---|---|---|
| USB Version | Max. Speed | | Name | Name | Connectors |
| 1.1 / 1.0 | 12 | Mbps | — | — | Type-A, |
| | | | | | Type-B |
| 2.0 | 480 | Mbps | Hi-Speed USB | — | Type-A, |
| | | | | | Type-B, |
| | | | | | Type-C, |
| | | | | | Mini, Micro |
| 3.0 | 5 | Gbps | SuperSpeed | USB 5 Gbps | Type-A, |
| 3.1 Gen 1 / | | | USB | | Type-B, |
| 3.2 Gen 1 | | | | | Type-C, |
| | | | | | Micro |
| 3.1 Gen 2 / | 10 | Gbps | SuperSpeed | USB 10 Gbps | Type-A, |
| 3.2 Gen 2 | | | USB 10 Gbps | | Type-C |
| 3.2 Gen 2 × 2 | 20 | Gbps | SuperSpeed | USB 20 Gbps | Type-C |
| | | | USB 20 Gbps | | |
| USB4 | 20 / 40 | Gbps | — | USB 20 Gbps / | Type-C |
| | | | | USB 40 Gbps | |
| USB4 Version 2 | 80 | Gbps | — | — | Type-C |

(USB 2.0)

### Overview

Data storage product capacities are often limited by memory technology limitations. In some SSD examples, using quad-level-cell (QLC) NAND technology, the maximum memory capacity of the SSD may be 8 Terabytes (TB). For example, the SSD may be configured with four NAND chips, each capable of storing 2 TB of data. The four 2 TB NAND chips are connected via four Flash Interface Module (FIM) channels to a single data storage controller, which may be configured as an application specific integrated circuit (ASIC).

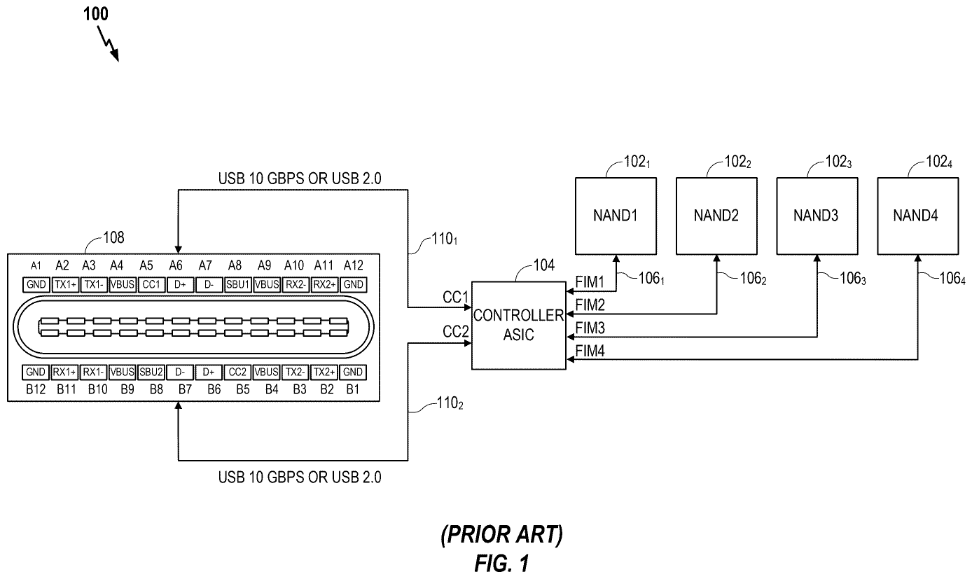

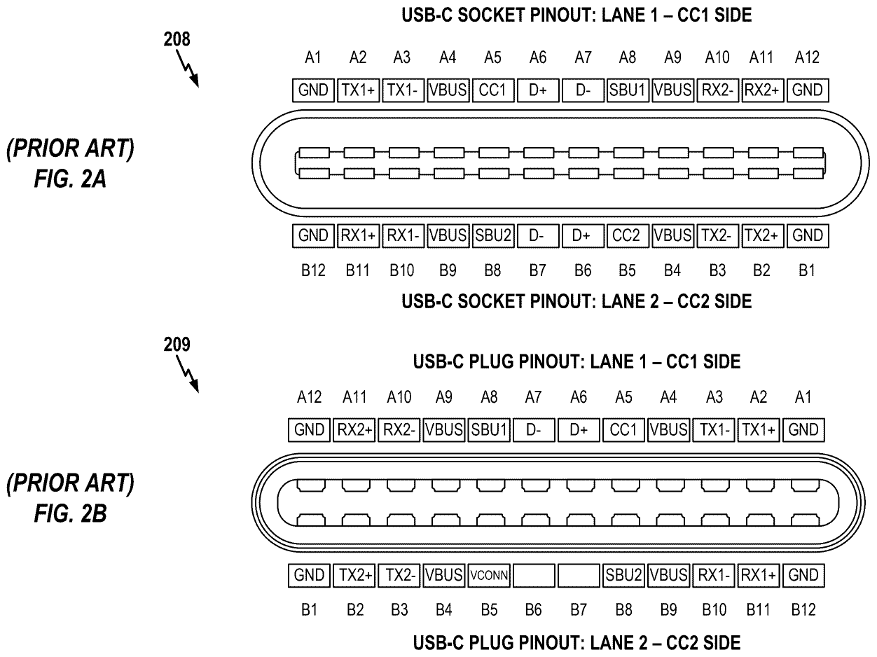

FIG. 1 illustrates a prior art example of an SSD 100 with four NAND chips 102₁-102₄ connected to a data storage controller 104 via four FIM channels 106₁-106₄. The SSD 100 also includes a USB-C connector socket (or receptable) 108 that accommodates two communication lanes. (Sec, also, FIG. 2 for an enlarged view of the USB-C connector socket pinout.) A first communication lane 110₁ is connected from the data storage controller 104 to a first row of pins of the USB-C connector socket 108. A second communication lane 110₂ is connected from the data storage controller 104 to a second row of pins in the USB-C connector socket 108. Although not shown in FIG. 1, the data storage controller 104 includes frontend components that implement a USB-C-compatible protocol (such as USB 10 Gbps) for use with the USB-C connector socket 108 and backend components that interface with the FIM channels that connect to individual NAND chips 102₁-102₄ of the SSD for storing (programming) data to the NAND chips and for reading (sensing) out data from the NAND chips. In other examples, the frontend components may be configured to operate at other rates, such as 12 Mbps, 480 Mbps, or 5 Gbps. Thus, the rate of 10 Gbps is just one example.

The data storage controller 104 of FIG. 1 is configured to provide a throughput of 10 Gbps from the NAND chips to an external host via the USB-C connector socket and a USB-C cable via either the first lane or the second lane, depending upon the orientation of the USB-C connector plug that is inserted into the USB-C connector socket. That is, the exemplary SSD 100 of FIG. 1 is not capable of 20 Gbps data transfer, even though the USB-C cable and the host may be capable of 20 Gbps data transfer (or even higher rates, such as 40 Gbps or 80 Gbps). The SSD 100 of FIG. 1 is capable of only 10 Gbps, either using lane 110₁ or lane 110₂, because its data storage controller and its FIM channels are only capable of a maximum of 10 Gbps (e.g., they are configured for use with USB 10 Gbps). To accommodate 20 Gbps, the SSD would require more expensive components that require more power and generate more heat, such as data storage controller ASICs configured for use with USB4 rather than USB 10 Gbps. Thus, SSD 100 of FIG. 1 is capable of either transferring data at 10 Gbps via lane 110₁ or transferring data at 10 Gbps via lane 110₂, but not both concurrently. The SSD 100 of FIG. 1 is also provided with only a total of four NAND chips providing 8 TB of memory.

FIG. 2 provides an enlarged view of a conventional USB-C connector socket 208, which is configured to receive a USB-C connector plug 209 of an external USB-C cable that may be connected into a host, such as a laptop computer of a user. The USB-C connector socket 208 has a physically symmetric pinout with two sets of signal pins, one on the top row and one on the bottom row, which are physically aligned with one another so the USB-C connector plug can be inserted into the USB-C connector socket 208 in either of two opposite mating orientations. As such, the USB-C connector plug is reversible and can be removed from the USB-C connector socket 208, its orientation flipped, then re-inserted into the USB-C connector socket 208 and it will again fit. However, the pinout of the USB-C connector socket 208 and the corresponding USB-C connector plug 209 are not electrically symmetric.

The electrical interface provided when the USB-C connector plug 209 is inserted in one orientation differs from the electrical interface provided when the USB-C connector plug 209 is inserted in the opposite orientation. Notably, one set of pins (e.g., the upper set) in the socket 208 has a configuration channel 1 (CC1) pin and the other set in the socket 208 (e.g., the lower set) has a CC2 pin. However, in the corresponding plug 209, the pinout includes only a single CC pin (CC1). There is no corresponding CC2 pin in the plug. As such, either the CC1 of the plug is connected to the CC1 of the socket (with the CC2 of the socket not connected to a corresponding CC pin) or the CC1 of the plug is connected to the CC2 of the socket (with the CC1 of the socket not connected to a corresponding CC pin). This enables the host and the SSD to detect the orientation of the USB-C connector plug to enable the correct lane for communication (i.e., lane 110₁ or 110₂ of FIG. 1). If CC1 of the plug is electrically connected to the CC1 of the socket, the first lane 110₁ is enabled and used for communication. If the USB-C connector plug is reversed, CC1 of the plug is electrically connected to CC2 of the socket and the second lane 110₂ is enabled and used for communication. (Note that the VCONN pin of the USB-C plug can also function as a configuration channel pin. Thus, if the SSD has a plug, rather than a socket, one of the lanes of the SSD can be connected to the CC1 of the plug while the other lane of the SSD can be connected to the VCONN pin. Thus, herein, the VCONN pin is also considered to be a configuration orientation pin.)

Thus, when using the SSD of FIG. 1, the user of the host can access the four NAND chips (for a total of 8 TB of memory) via either the first or second lanes (110₁ and 110₂). From the user's point of view, the orientation of the USB-C connector plug does not matter and so the plug can be inserted in either orientation. However, the SSD is provided with only 8 TB of total memory. It would be desirable to instead provide an SSD with 16 TB of memory, yet without requiring the provision of a more expensive and more power consuming (and more heat generating) data storage controller equipped to accommodate the 16 TB of memory. In the following, a solution to this problem is provided.

Briefly, an SSD is described herein that includes two (relatively inexpensive) data storage controller ASICs, each configured to accommodate a total memory space of 8 TB with a data transfer throughput of 10 Gbps (e.g., USB 10 Gbps) or a lower rate such as 480 Mbps of USB 2.0. A first set of four 2 TB NAND chips is coupled to a first data storage controller, and a second set of four 2 TB NAND chips is coupled to a second data storage controller, for a total of 16 TB, thus doubling the capacity of the SSD of FIG. 1. One lane of the USB-C connector socket is connected to the first data storage controller and its corresponding NANDs. The second lane of the USB-C connector socket is connected to the second data storage controller and its corresponding NANDs. At any given time, depending upon the mating orientation of the plug in the socket, only one of the two CC pins (CC1 or CC2) of the socket is connected to the corresponding CC1 pin of the plug to enable either the first lane or the second lane to be active for 10 Gbps signaling. Thus, only one of the two sets of NAND chips is accessible at 10 Gbps to the user via the host.

However, the other one of the data storage controllers can currently transfer data at 480 Mbps in accordance with USB. 2.0. Referring again to FIGS. 2A and 2B, the USB-C socket pinout includes two pairs of TX/RX and two pairs of D+/D−, as well as the two CC pins. For a single lane operation (USB 10 Gbps), only one set of the pins is used. The CC pins (CC1 and CC2) are used to detect the orientation of the cable and enable the correct lane for communication. Note that the USB-C plug includes only one D+/D− pair, which is on lane 1. Upon connecting the SSD with the USB-C cable (which connects the SSD with the host), there is only one lane of D+ and D− travelling inside the cable, unlike TX and RX. This lane is used for USB 2.0 communications while USB 10 Gbps communications are concurrently performed.

Thus, in some aspects, one lane within the SSD is used for USB 10 Gbps (via one of the two data storage controllers) while the other lane uses USB 2.0 (via the other of the two data storage controllers), allowing for concurrent transmissions of data at 10 Gbps and at 480 Mbps. Depending upon the mating orientation of the plug in the socket, either lane 1 is used for 10 Gbps and lane 2 is used for at 480 Mbps, or lane 1 is used for 480 Mbps and lane 2 is used for 10 Gbps. When the user connects the SSD in the first mating orientation, lane 1—which connects to the first data storage controller and its NANDs on “side 1” of the SSD—is enabled for access by the host to the first set of NAND chips at 10 Gbps. Concurrently, lane 2—which connects to the second data storage controller and its NANDs on “side 2” of the SSD—is enabled for access by the host to the second set of NAND chips at 480 Mbps via USB 2.0. If the user flips the USB-C connection plug (or flips the SSD itself) and re-connects the SSD to the host, lane 2 is enabled for access to the second set of NAND chips by the host at 10 Gbps. Concurrently, lane 1 is enabled for access to the first set of NAND chips by the host at for 480 Mbps via USB 2.0. That is, a flip of the USB-C connector plug within the SSD's USB-C connector socket enables the user to switch the storage space access speeds when accessing the two 8 TB memory spaces. The total 16 TB of storage space is accessible in either case.

The SSD may be connected to a host via a cable or the SSD might be configured as a thumb drive (or memory stick, pen drive, etc.) for directly attaching to a host, depending upon the particular communication protocol or interface. (For USB-C, since the pinout of a USB-C plug is different from the pinout of a USB-C socket, some of the devices and procedures described herein might not work with a thumb drive configured with only a USB-C plug. This may depend on whether the plug is provided with two pairs of D+ and D− pins, as with the socket. For other interfaces besides USB-C, such as Thunderbolt 4, at least some of the devices and procedures described herein may work for a thumb drive, depending upon the particular pinouts of the plug.) If a cable is used, the cable may be flipped and then re-inserted into the socket of the SSD. If the SSD is configured as a thumb drive, the thumb drive itself may be disconnected from the host, flipped, and then reattached. Note also that the USB2.0 (480 Mbps) lane/protocol could also be USB1.1 (12 Mbps). That is, USB2.0/1.1. Similarly, the 10 Gbps could instead be 5 Gbps. That is, the USB 2.0/USB 10 Gbps configuration is just one example.

Further, in some aspects, background data transfers may be performed to one of the sets of NAND chips at USB 2.0 while the user accesses the other set of NAND chips at 10 Gbps, e.g., for computer gaming or the like. In still other aspects, automatic data backups from the host may be performed in the background via data transfers to one of the sets of NAND chips at USB 2.0 while the user accesses the other set of NAND chips at 10 Gbps. Herein, a background transfer refers to the transmission of data during non-busy periods. (For example, a metric may be defined that represents how busy or active a computing system is for comparison against a threshold. If the metric is below the threshold, background data transfers may be performed between host and SSD. The metric may be based, e.g., on the percentage of a CPU utilization percentage.) For example, a custom application may be deployed on various platforms that performs a background auto-backup of data from selected folders on a host to the SSD via a USB2.0/8 TB partition. In some aspects, the USB2.0/8 TB partition may be hidden from the user and only the other 8 TB partition (accessible via USB 10 Gbps) is exposed to the user for data transfers. The power circuitry in the SSD may be configured to control power based on the mating configuration. For example, the data storage controller that is connected to the lane operating at USB 2.0 may be delivered reduced power as compared to the data storage controller that is connected to the lane operating at USB 10 Gbps. Power reduction is optional. In other examples, both data storage controllers and their respective NANDs remained fully powered-up. In still other aspects, the host may be notified to inform the user that the different connection speeds may be obtained by flipping the mating orientation.

In this manner, 16 TB of memory space is provided to the user without requiring the use of more expensive data storage controller ASICs and, in some examples, without consuming significantly more power or generating significantly more heat.

In some examples, a portable SSD may be provided that can be easily flipped by the user to access a different “side” of the SSD (via reinsertion the USB-C connection plug in the opposite orientation) to mimic the manner by which one flips a record to listen to a different side of the record. The SSD may have, for example, different graphics on one side of the SSD compared to the other side surface, or may have different colors (e.g., red vs blue). This helps emphasize to the user that there are two separate memory spaces that are accessible concurrently at different connection speeds. In one aspect, one side of the SSD may be used for high speed transference of personal data (e.g., videos, computer game data, etc.), while the other side may be used for low speed transference of work data (e.g., spreadsheets, etc.). The file explorer in the host may be configured to shows two drives (e.g., a first 8 TB “drive” accessible via USB 10 Gbps and a second 8 TB drive accessible via USB 2.0) in addition to the local disk C of the host (which includes the host's operating system).

In other aspects, portable data storage devices are provided with two separate memory spaces or partitions formed of NAND dies of different die quality grades, which appear to the user of a host computer as separate drives (rather than as a single memory space). For example, a first memory space may consist of one or more NANDs dies of the highest quality (e.g., prime or enterprise grade dies), whereas a second memory space may consist of one or more NAND dies of a lower quality (e.g., non-prime or archival grade dies). The data storage device is configured with a multiplexer so the user can easily select between the two memory spaces depending upon current storage needs. For example, the prime grade memory space may be used for storing “hot data” that requires frequent access, whereas the non-prime grade memory space may be used for storing “cold data,” e.g., for archival purposes. In some examples, a command is sent by the user from the host to the data storage device to switch between the memory spaces. In other examples, a switch or button is provided on the external housing of the data storage device to enable the user to control memory space selection.

The quality of the dies may be determined initially during a binning process that rates dies based on factors such as the number of defects and the expected endurance, e.g., an expected number of programmed/erase (P/E) cycles that the die can accommodate. Different vendors may provide different binning codes that represent the different quality grades of NAND dies. In one example, prime is the highest quality, followed by Cherry Picked Fall Out (CPFO) dies, then BinAA down to BinZZ, with a code of 11 indicating a dead die. CPFO refers to dies that fail to achieve prime status but are nevertheless selected as quality dies. They are often in high demand. In other examples, NAND dies may be rated, in descending order of quality, as: Enterprise, High-end consumer, Mainstream consumer, Budget, and Archival. The quality of a NAND die may be quantified in terms of raw bit error rate (RBER) before error correction code (ECC) mitigation. A prime quality NAND die may have, for example, 100-1,000 defects per billion bits, whereas an archival quality NAND die may have 10,000-100,000 defects per billion bits when fresh. Suitable RBER thresholds may be used to distinguish among the various categories of NAND dies, along with other factors such as expected endurance.

Prime dies are well-suited for high-density quad-level cell (QLC) storage because the dies can reliably store four bits per cell without requiring a great amount of ECC processing, as might be needed with a lower quality die with a higher RBER. An archival quality die might also be used for QLC storage but with the need for more sophisticated and complex ECC, which can be more time consuming (e.g., imposing greater latency) and more power consuming (which can be an issue for external drives that do not have their own power supply).

In still other aspects, portable data storage devices are provide having two separate memory spaces or partitions, one being an SSD (having NAND dies) and the other consisting of a magnetic storage device such as a hard disk drive (HDD), which appear to the user of a host computer as separate drives (rather than as a single memory space). The data storage device is configured with a multiplexer so the user can easily select between the SSD and the HDD depending upon current storage needs. For example, the SSD may be used for storing hot data, whereas the HDD may be used for storing cold data. In some examples, a command is sent by the user from the host to the data storage device to switch between the memory spaces. In other examples, a switch or button is provided on the housing of the data storage device to control memory space selection.

In still other aspects, portable data storage devices are provided with two memory spaces or partitions wherein a connection between the device and a host accommodates concurrent communication using two different communication protocols (e.g., USB 10 Gbps and USB 2.0 at 480 Mbps) via two different communication lanes. A lane control switch is provided to allow the user to select which memory space accesses the faster communication protocol (e.g., USB 10 Gbps) and which memory space accesses the slower communication protocol (e.g., USB 2.0 at 480 Mbps). In some examples, a command is sent by the user from the host to the data storage device to switch or swap the communication protocols. In other examples, a switch or button is provided on the housing of the data storage device to switch or swap the communication protocols. Note that the terms connection lane and communication lane may be used interchangeably.

In yet other aspects, a portable data storage device with two memory spaces or partitions is provided with colors or other markings or indicia on the device and on a connection cable to indicate proper alignment of a symmetric USB-C connection cable into the device. This is advantageous for use with a data storage device that is not provided with a lane control switch (discussed above). The user thus needs to insert the connection cable with proper alignment so that the memory space intended for storing hot data is properly connected to a high speed connection lane (e.g., USB 10 Gbps), whereas the memory space intended for storing cold data is connected to the slower speed connection lane (e.g., USB 2.0). In one example, one side of the portable data storage device is black and the other side is red. Likewise, one side of the USB-C connection cable plug is black and the other side is red. When the cable plug is inserted with the black side matching the black side of the portable device, the memory space intended for storing hot data is properly connected to the high speed connection lane (e.g., USB 10 Gbps) and the memory space intended for storing cold data is connected to the slower speed connection lane (e.g., USB 2.0). Instead of colors, are indicia may be used.

These and other features will be described in detail in the following sections.

Exemplary SSD with Two Separate Memory Spaces and Memory Controllers

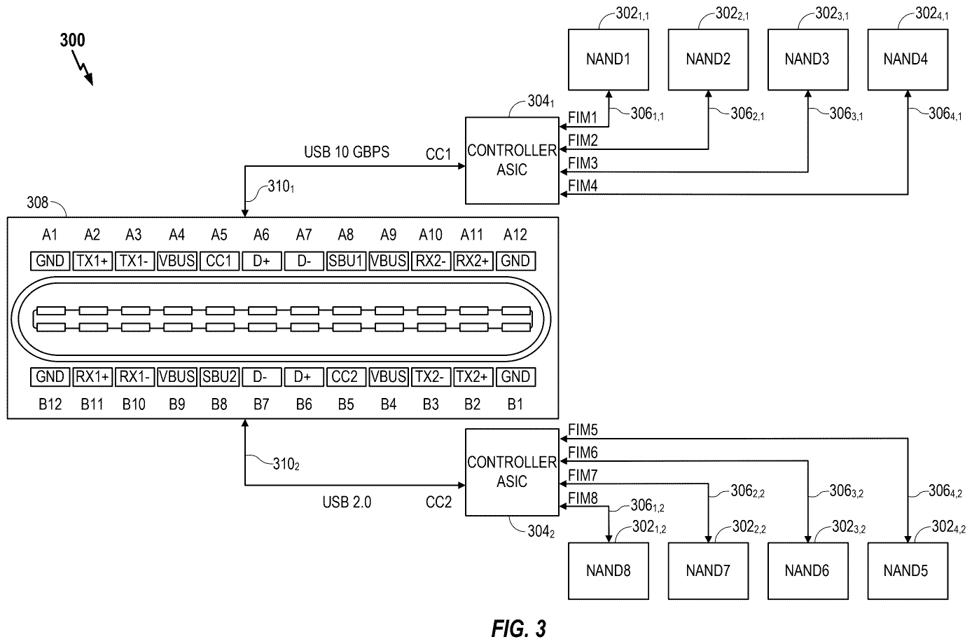

FIG. 3 illustrates an SSD 300 configured in accordance with aspects of the present disclosure wherein two data storage controllers are provided, each connected to four NAND chips, thus providing a total memory capacity of 16 TB. SSD 300 has a first set of four NAND chips 302_{1,1}-302_{4,1} connected to a first data storage controller 304₁ via four FIM channels 306_{1,1}-306_{4,1}. The SSD 300 also includes a USB-C connector socket (or receptable) 308 (see, again, FIG. 2) that accommodates two communication lanes. A first communication lane 310₁ is connected from the data storage controller 304₁ to a first row of pins of the USB-C connector socket 308. The second communication lane 310₂ is connected to a second data storage controller 304₂ via a second row of pins in the USB-C connector socket 308. The second data storage controller 304₂ is connected to a second set of four NAND chips 302_{1,2}-302_{4,2} via four FIM channels 306_{1,2}-306_{4,2}. Although not shown in FIG. 3, each of the two data storage controllers 304₁, 304₂ includes frontend components that implements at least two USB-C-compatible protocols (such as USB 10 Gbps and USB 2.0) for use with the USB-C connector socket 308 and backend components that interface with the corresponding FIM channels that connect to the corresponding NAND chips of the SSD for storing (programming) data to the NAND chips and for reading out (sensing) data from the NAND chips.

The two data storage controllers 304₁, 304₂ of FIG. 3 are each configured to provide a throughput of either 10 Gbps or 480 Mbps from the NAND chips to an external host via the USB-C connector socket and a USB-C cable via its corresponding lane. However, only one of the two lanes 310₁, 310₂ is enabled at any given time for USB 10 Gbps based on the mating orientation of the USB-C connector plug (see, again, FIG. 2) in the USB-C connector socket 308, while the other of the two lanes is enabled for USB 2.0 480 Mbps. The CC pins (CC1 and CC2) of the USB-C connector socket 308 are used by the host and the SSD 300 to detect the orientation of the USB-C connector plug to enable a particular lane for 10 Gbps communication (i.e., lane 310₁ or 310₂) while the other lane is enabled for concurrent 480 Mbps communication. As noted above, when the USB-C plug is inserted, only one of the two CC pins in the USB-C socket is electrically connected to the host. If CC1 is electrically connected, then the first lane 310₁ is enabled for USB 10 Gbps (as shown) and NAND chips 302_{1,1}-302_{4,1} are accessible to the host at that speed, while the other lane 310₂ is enabled for USB 2.0 (as shown) and NAND chips 302_{1,2}-302_{4,2} are accessible to the host at the slower speed of 480 Mbps. If the USB-C connector plug is reversed (flipped), then CC2 is electrically connected and the second lane 310₂ is enabled for USB 10 Gbps and NAND chips 302_{1,2}-302_{4,2} are accessible to the host at that speed, while the other lane 110₁ is enabled only for USB 2.0 and NAND chips 302_{1,1}-302_{4,1} are accessible to the host at that slower speed. (This alternative configuration where lane 1 is USB 2.0 and lane 2 is USB 10 Gbps is not shown in FIG. 3.) Note also that the USB2.0 (480 Mbps) lane/protocol could also be USB1.1 (12 Mbps). That is, USB2.0/1.1. Similarly, the 10 Gbps could instead be 5 Gbps. That is, the USB 2.0/USB 10 Gbps configuration is just one example.

Notably, both data storage controller 304₁ and data storage controller 304₂ can be relatively inexpensive data storage controller ASICs configured to use with a maximum of four FIMs at a maximum throughput of 10 Gbps. Moreover, in some examples, whichever data storage controller is currently being used for USB 2.0 can use reduced power to reduce overall power consumption and reduce heat. If the user then reverses the USB-C connector plug, the opposite lane is enabled, and so the data storage controller that was being given reduced power is powered up, whereas the other data storage controller is a now given reduced power. In some examples, one set of NAND chips may be used by a user for personal data (e.g., videos, computer game data, etc.), while the other set of NAND chips may be used for work data (e.g., spreadsheets, etc.) In other examples, one set of NAND chips may be used by the user for primary data storage while the other set of NAND chips may be used for data backup.

As noted above, one set of NAND chips may be regarded as representing one “side” of the SSD, whereas the other set of NAND chips may be regarded as representing the other “side” of the SSD. To access a first side of the SSD using USB 10 Gbps, the USB-C plug is inserted into the USB-C socket in one orientation. To access the other side of the SSD at USB 10 Gbps, the USB-C plug may be removed, the SSD flipped up-side-down, and then the plug is reinserted into the USB-C socket. Alternatively, the USB-C plug is flipped, then reinserted.

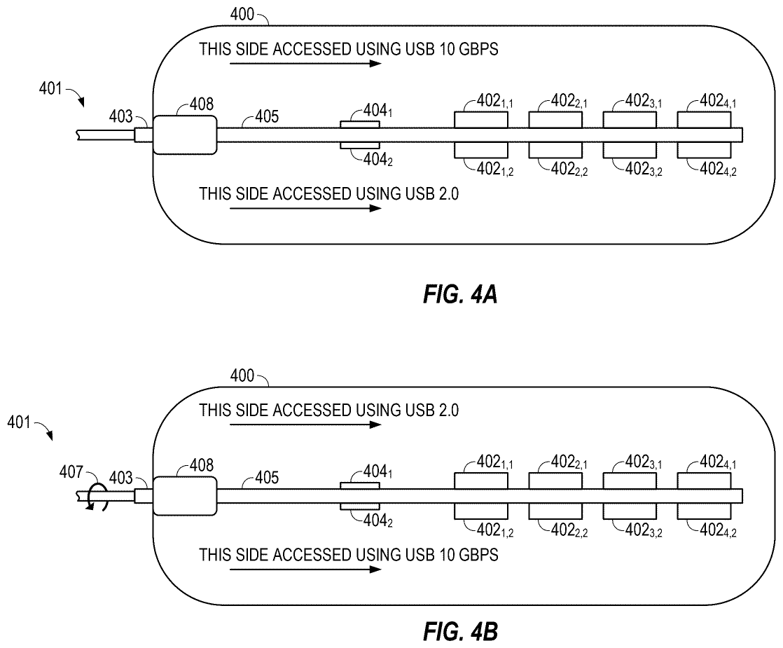

FIGS. 4A and 4B further illustrate how one “side” or the other of an SSD may be accessed using USB 10 Gbps while the other side is accessed using USB 2.0, either by flipping the USB-C cable plug and then reinserting the plug into the SSD or, equivalently, by flipping the SSD and then reinserting the USB-C cable plug into the SSD.

FIG. 4A illustrates an SSD 400 with a USB-C cable 401 having a USB-C cable plug 403 inserted into a USB-C cable socket 408. Although not shown in the figure, the opposite end of the USB-C cable 401 is connected into a host. In the orientation of FIG. 4A, a data storage controller 404₁ is enabled to provide access by the host to a first set of NAND chips 402_{1,1}-402_{4,1} with data transfers to/from the host performed using USB 10 Gbps while a data storage controller 4042 is enabled to provide access by the host to a second set of NAND chips 402_{1,2}-402_{4,2} with data transfers to/from the host performed using USB 2.0. Note that the figure shows a central bar 405 that conceptually represents various connection lanes, busses and/or FIMs that interconnect the various components. Notably, as explained above, separate FIMs and connection lanes are provided for the two separate data storage controllers and their corresponding NAND chips. For clarity, the separate lanes, FIMS, etc., are omitted.

FIG. 4B illustrates the SSD 400 with the USB-C cable 401 flipped (as shown by arrow 407) with its USB-C cable plug 403 inserted into the USB-C cable socket 408 in the opposite orientation. In the configuration of FIG. 4B, data storage controller 4042 is enabled to provide access by the host to the first set of NAND chips 402_{1,2}-402_{4,2} with data transfers to/from the host performed using USB 10 Gbps while data storage controller 404₁ is enabled to provide access by the host to the first set of NAND chips 402_{1,1}-402_{4,1} with data transfers to/from the host performed using USB 2.0. Alternatively, the SSD itself may be flipped, with the USB-C cable plug reinserted so as to flip the orientation of the plug in the socket without flipping the plug. Note that, in some examples, the first side of the SSD (i.e., NAND chips 402_{1,1}-402_{4,1}) may be used for storing work (or official data) such as spreadsheets, filed, etc., whereas the other side of the SSD (i.e., NAND chips 402_{1,2}-402_{4,2}) may be used for storing personal data such as videos, movies, etc.

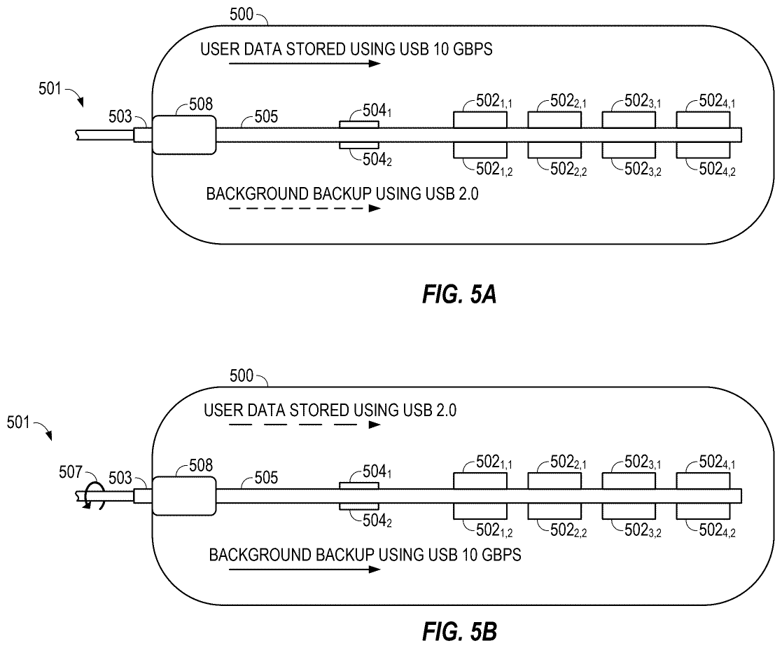

FIGS. 5A and 5B illustrates a use case in which one side of an SSD may be used by user for storing data using USB 10 Gbps while, concurrently, an automatic background backup of host data is performed the other side of the SSD using USB 2.0. In some examples, the host does not show the second (side 2) partition of the drive within the file explorer of the host, only the side 1 partition. In other examples, both partitions are shown. As noted above, a custom application may be deployed on various platforms that performs a background auto-backup of data from selected folders on a host to the SSD via USB2.0.

FIG. 5A illustrates an SSD 500 with a USB-C cable 501 having a USB-C cable plug 503 inserted into a USB-C cable socket 508. Although not shown in the figure, the opposite end of the USB-C cable 501 is connected into a host operator by a user. In the orientation of FIG. 5A, a data storage controller 5041 is enabled to provide access by the user at 10 Gbps to a first set of NAND chips 502_{1,1}-502_{4,1} for storage of data that may be, e.g., work data, personal data, or a combination of both. Concurrently, an automatic background backup is performed by the host using USB 2.0 to a second set of NAND chips 502_{1,2}-502_{4,2}. This backup may be transparent to the user who is only made aware by the host operating system (OS) of the first partition corresponding to NAND chips 502_{1,1}-402_{4,1}. In other examples, the user is made aware of the partition/backup, as well as the backup speed of 480 Mbps.

FIG. 5B illustrates the SSD 500 with the USB-C cable 501 flipped (as shown by arrow 507) with its USB-C cable plug 503 inserted into the USB-C cable socket 508 in the opposite orientation. In the configuration of FIG. 5B, access by the user to the first partition NAND chips 502_{1,1}-502_{4,1} is only at 480 Mbps, while the backup is performed to the second partition NAND chips 502_{1,2}-502_{4,2} at 10 Gbps. This may be appropriate if, for example, the user wants to provide a very fast backup (10 Gbps) and does not currently need fast access to the data within the first partition NAND chips 502_{1,1}-502_{4,1}. The figures show a central bar 505 that conceptually represents various connection lanes, busses and/or FIMs that interconnect the various components. The separate lanes, FIMS, etc., are omitted in FIGS. 5A and 5B.

Note also that the host devices described herein may be referred to as having a Downstream Facing Port (DFP), i.e. a USB port functioning as a host and power source. The SSDs described herein may be referred to as having an Upstream Facing Port (UFP), i.e., a USB port serving as a client and power sink. At least some aspects of the disclosure may also be applicable to a Dual Role Device (DRD), which is capable of functioning as either a host or client (and formerly referred to as an on-the-go (OTG) device). At least some aspects of the disclosure may also be applicable to Dual Role Power (DRP) devices, i.e., devices capable of operating as either a power provider or power consumer. Note also that the CC pins discussed above not only enable detection of cable orientation (mating orientation), but the pins also enable identifying device roles to prevent damage and define communication hierarchy, and enable negotiating of power configurations between client and host devices for power distribution.

Co-pending U.S. patent application Ser. No. 18/954,904, filed on Nov. 21, 2024, entitled “DATA STORAGE DEVICE WITH DUAL MEMORY SPACES ENABLED BASED ON THE MATING ORIENTATION OF REVERSIBLE CONNECTOR,” (Atty. Docket No. WDT-1462 (WDA-7823-US))), and assigned to the assignee of the present application, is fully incorporated by reference herein for all purposes, and it should be understood that various features and inventions of the present application and the co-pending application can be practiced together. By way of example and not limitation, an SSD may be provided that is configured to either (a) enable concurrent operation of both data storage controllers and connection lanes to permit, e.g., USB 10 Gbps protocol data transfers via one of the connection lanes and simultaneous 480 Mbps USB 2.0 protocol transfers via the other of the connection lanes or (b) fully disconnect one of its data storage controllers and connection lanes depending upon the mating orientation of the USB-C plug as described in the co-pending application.

### Additional Exemplary SSDs

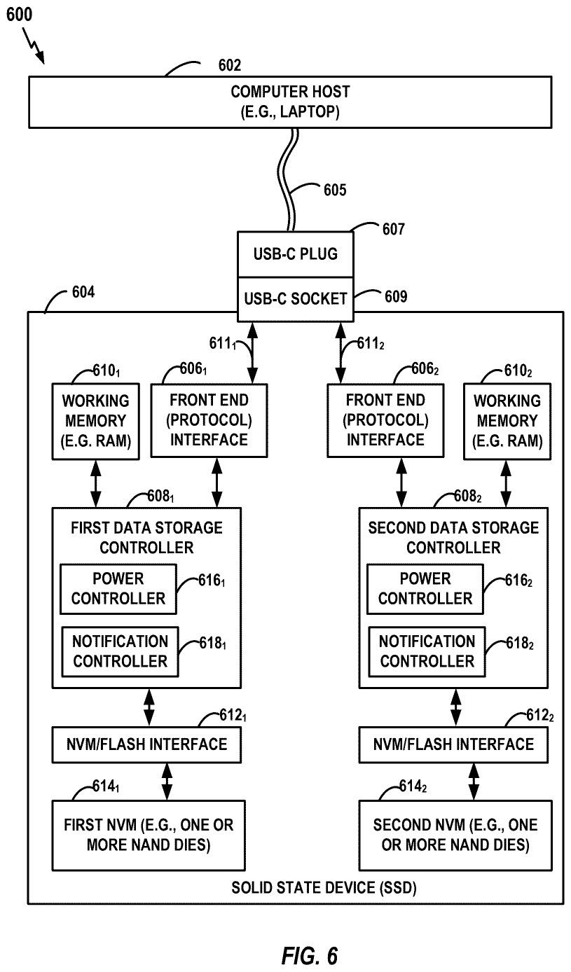

FIG. 6 is a block diagram of a system 600 including an exemplary computer host 602 (e.g., a laptop) and a solid state device (SSD) 604 configured with two data storage controllers and two NVM arrays. The host 602 is connected to the SSD 604 using an external USB-C connection cable 605 having a USB connection plug 607 for insertion into a USB-C connection socket 609 of the SSD in one of two mating orientations (as explained above).

The SSD 604 is configured to provide concurrent access to both the first and the second NVM array by the computer 602 with the connection speed/protocol depending upon the mating orientation. For example, in the first mating orientation, in which a first data storage controller 608₁ and a first NVM array 614₁ are communicatively coupled to the host 602 using USB 10 Gbps, the host 602 may provide a write command to the SSD 604 for writing user data to NVM 614₁ or a read command for reading user data from the NVM 614₁, with access by the host 602 to the NVM 614₁ under the control of data storage controller 608₁. Concurrently, the host 602 may provide a write command to the SSD 604 for writing user data to NVM 614₂ or a read command for reading user data from the NVM 614₂, with USB 2.0 access by the host 602 to the NVM 614₂ under the control of data storage controller 608₂.

In the second mating orientation, in which the second data storage controller 608₂ and the second NVM array 614₂ are communicatively coupled to the host 602 using USB 10 Gbps, the host 602 may provide a write command to the SSD 604 for writing user data to NVM 614₂ or a read command for reading user data from the NVM 614₂, with access by the host 602 to the NVM 614₂ under the control of data storage controller 608₂. Concurrently, the host 602 may provide a write command to the SSD 604 for writing user data to NVM 614₁ or a read command for reading user data from the NVM 614₁, with USB 2.0 access by the host 602 to the NVM 614₁ under the control of data storage controller 608₁.

The SSD 604 includes a front end (protocol) interface 6061 for interfacing with host 602 via the USB-C-compatible protocol using a first connection lane 611₁. The SSD 604 also includes a working memory 610₁ (such as RAM), an NVM interface 612₁ (which may be referred to as a flash interface or backend interface), and the NVM 614₁, such as one or more NVM NAND dies or NVM arrays. The data storage controller 608₁ includes a power controller 616₁ and a notification controller 618₁. The power controller 616₁ provides full power to the data storage controller 608₁ (and other components such as working memory 610₁) while the USB plug 607 and USB socket 609 are in the first mating configuration, but reduces power to those components while the USB plug 607 and USB socket 609 are in the second mating configuration. The notification controller 618₁ notifies the host 602 of the NVM 614₁ that is accessible at USB 10 Gbps while the USB plug 607 and USB socket 609 are in the first mating configuration. The notification controller 618₁ also notifies the host 602 that the second NVM 614₂ instead can be accessed at USB 10 Gbps if the user flips the USB plug 607 and USB socket 609 to the second mating configuration. The host 602 can then notify the user of that option via an appropriate display screen indication.

The SSD 604 also includes a front end (protocol) interface 606₂ for interfacing with host 602 via the USB-C-compatible protocol using a second connection lane 611₂. The SSD 604 also includes a working memory 610₂ (such as RAM), an NVM interface 612₂ (e.g., flash interface or backend interface), and the NVM 614₂, such as one or more NVM NAND dies or NVM arrays. The data storage controller 608₂ also includes a power controller 616₂ and a notification controller 618₂. The power controller 616₂ provides full power to data storage controller 608₂ (and other components such as working memory 610₂) while the USB plug 607 and USB socket 609 are in the second mating configuration, but reduces power to those components while the USB plug 607 and USB socket 609 are in the first mating configuration. The notification controller 618₂ notifies the host 602 of the NVM 614₂ that is accessible at USB 10 Gbps while the USB plug 607 and USB socket 609 are in the second mating configuration. The notification controller 618₂ also notifies the host 602 that the first NVM 614; instead can be accessed at USB 10 Gbps if the user flips the USB plug 607 and USB socket 609 to the first mating configuration. The host 602 can then notify the user of that option via an appropriate display screen indication.

Note that although the power controllers and notification controllers are shown as components of the data storage controllers, they may be implemented as separate components. Moreover, rather than having separate power controllers and notification controllers, as shown, a single power controller and/or single notification controller can instead be provided, i.e., as components that are separate from the data storage controllers.

In the primary examples herein, the host 602 is a laptop computer. However, host 602 may be any system or device needing data storage or retrieval and a compatible interface for communicating with the SSD 604. For example, the host 602 may be a computing device, a desktop computer, a personal computer, a portable computer, a workstation, a server, a personal digital assistant, a digital camera, an Internet of Things (IoT) device, or a mobile phone. Still further, in some examples, the host may be any other device accessible via USB-C or a similar communication interface having a reversible connection scheme.

In the primary examples described herein, the cable 605 provides a USB-C interface. However, in other examples, other suitable communication interfaces may be used, if configured with reversible connectors that can be physically coupled in one of two mating configurations, e.g., the connectors have a physically symmetric but electrically asymmetric pinout to thereby permit the mating orientation to be detected from the electrical asymmetry. For example, the Thunderbolt 4 interface is reversible. Aspects described herein may also be applicable to the Peripheral Component Interconnect Express (PCIe) interface. Future versions of USB interfaces are also expected to be reversible.

Note that the data storage controllers 608₁ and 608₂ of FIG. 6 may include any type of processing device, such as a microprocessor, a microcontroller, an embedded controller, a logic circuit, software, firmware, or the like, for controlling the operation of the SSD 604. In some aspects, some or all of the functions described herein as performed by one or both of the data storage controllers may instead be performed by another element of the SSD 604. For example, the SSD 604 may include a microprocessor, a microcontroller, an embedded controller, a logic circuit, software, firmware, or any kind of processing device, for performing one or more of the functions described herein as being performed by one or both of the data storage controllers.

The working memories 610₁ and 610₂ of FIG. 6 may be any suitable memory or system capable of storing data. For example, the memories may be ordinary RAM, DRAM, double data rate (DDR) RAM, static RAM (SRAM), synchronous dynamic RAM (SDRAM), flash storage, an erasable programmable read-only-memory (EPROM), an electrically erasable programmable ROM (EEPROM), or the like. In various embodiments, the data storage controllers use the working memories, or portions thereof, to store data during the transfer (transference) of data between the host 602 and the NVMs. For example, the working memories or portions thereof may be a cache memory. The NVMs 614₁ and 614₂ may be any suitable type of non-volatile memory, such as a NAND-type flash memory or the like.

Although FIG. 6 shows an exemplary SSD that is configured as an SSD with flash NAND NVM, the various disclosed embodiments are not necessarily limited to an SSD application/implementation. The disclosed NVM dies and associated processing components can be implemented as part of a package that includes other processing circuitry and/or components. For example, a processor may include, or otherwise be coupled with, embedded NVM and associated circuitry and/or components. The processor could, as one example, offload certain tasks to the NVM and associated circuitry and/or components. Still further, the data storage device 604 may have volatile memory such as DRAM chips instead of NAND dies as its primary memory. That is, NVM 614₁ may instead be a first DRAM and NVM 614₂ may instead be a second DRAM. In such an implementation, the interfaces 612₁ and 612₂ would not be flash interfaces but double/dual data rate (DDR) interfaces for use with the DRAMs.

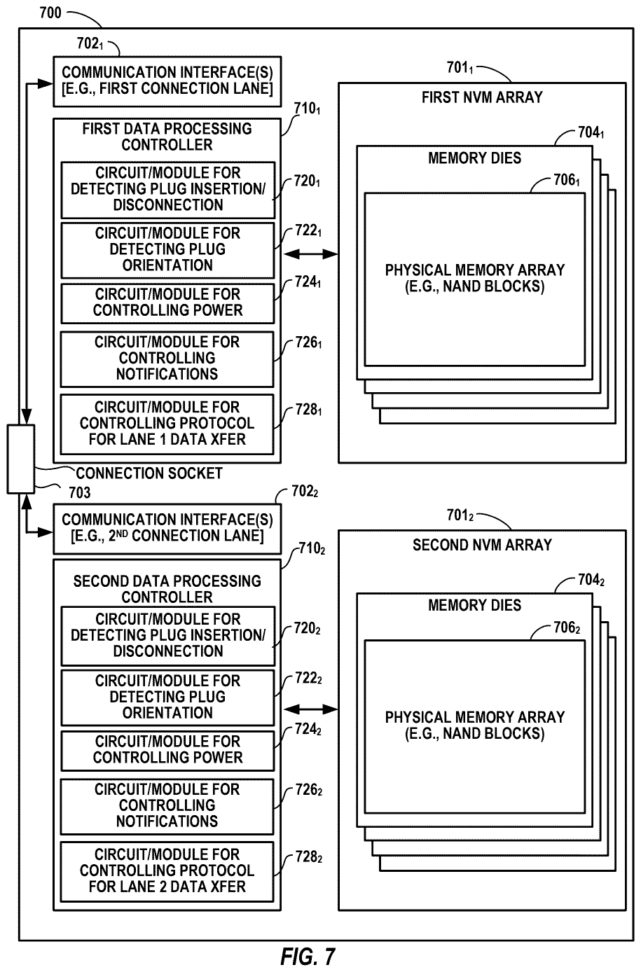

FIG. 7 illustrates an embodiment of an apparatus 700 configured according to one or more aspects of the disclosure. The apparatus 700, or components thereof, could embody or be implemented as a data storage controller within a portable SSD, or other type of device that supports computations and data storage.

The apparatus 700 has a first set of components denoted by subscript 1 and a second set of components denoted by subscript 2, whose operations may vary depending upon a plug orientation within a connection socket 703, which may be a USB-C connection socket. (In FIG. 7, the plug is not shown, but see, e.g., FIG. 6.) A first data processing controller 710₁ is communicatively coupled to a first NVM die array 701₁ that includes one or more memory dies 704₁, each of which may include physical memory arrays 706₁, e.g., NAND blocks. The data processing controller 710₁ may include various modules/circuits, including firmware (FW) components. These components can be coupled to and/or placed in electrical communication with one another and with the NVM die array 701₁ via suitable components, represented generally by connection lines in FIG. 7. Although not shown, other circuits such as timing sources, peripherals, voltage regulators, and power management circuits may be provided, which are well known in the art, and therefore, will not be described any further.

In some examples, the memory dies may include on-chip circuitry such as under-the-array circuitry. The memory dies 704₁ may be communicatively coupled to the data processing controller 710₁ such that the apparatus 700 can read or sense information from, and write or program information to, the physical memory array 706₁. That is, the physical memory array 706₁ can be coupled to controller 710₁ so that the physical memory array 706₁ is accessible by the controller 710₁. The dies may additionally include, e.g., input/output components, registers, voltage regulators, etc. The connection between the controller 710₁ and the memory dies 704₁ of the NVM die array 701₁ may include, for example, one or more busses.

The apparatus 700 includes a first communication interface 702₁, e.g. a first communication lane (lane 1), for connecting via socket 703 to a laptop, a mobile phone, etc. using, e.g., USB-C-compatible protocols (such as USB 10 Gbps or USB 2.0) other suitable communication protocols. More generally, the communication interface 702₁ provides a means for communicating with other apparatuses over a transmission medium. In some implementations, the communication interface 702₁ includes circuitry and/or programming (e.g., a program) adapted to facilitate the communication of information bi-directionally with respect to one or more devices in a system. In some implementations, the communication interface 702₁ may be configured for wire-based communication. For example, the communication interface 702₁ could be a send/receive interface or some other type of signal interface including circuitry for outputting and/or obtaining signals (e.g., signals to/from a host). The communication interface 702₁ serves as one example of a means for receiving and/or a means for transmitting.

The modules/circuits of the data storage controller 710₁ are arranged or configured to obtain, process, and/or send data, control data access and storage, issue or respond to commands, and control other desired operations. For example, the controller 710₁ may be implemented as one or more processors, one or more controllers, and/or other structures configured to perform functions. According to one or more aspects of the disclosure, the controller 710₁ may be adapted to perform any or all of the features, processes, functions, operations, and/or routines described herein as being performed by the data storage controller. For example, the controller 710₁ may be configured to perform any of the data storage controller steps, functions, and/or processes described with respect to FIGS. 3-6 and FIGS. 8-9, discussed below.

As used herein, the term “adapted” in relation to the data processing controller 710₁ may refer to the modules/circuits being one or more of configured, employed, implemented, and/or programmed to perform a particular process, function, operation and/or routine according to various features described herein. The modules/circuits may include a specialized processor, such as an application-specific integrated circuit (ASIC) that serves as a means for (e.g., structure for) carrying out any one of the data storage controller operations described in conjunction with, e.g., FIGS. 3-6 and 8-9. The modules/circuits serve as an example of a means for processing. In various implementations, the modules/circuits may provide and/or incorporate, at least in part, functionality described above for the components in various embodiments shown, including for example data storage controller 608₁ of FIG. 6.

According to at least one example of the apparatus 700, the data processing controller 710₁ may include one or more of: a circuit/module 720₁ for detecting plug insertion/disconnection via communication interface 702₁ (see, again, the USB-C plugs/sockets discussed above and the electrical asymmetry of the CC1 and CC2 pins); a circuit/module 722₁ for detecting plug orientation (by detecting, e.g., a CC1 connection instead of a CC2 connection) and, in response to a CC1 connection, for enabling access by a host via an external cable to the first NVM array 701₁ via the first connection lane at USB 10 Gbps, or, in response to a CC2 connection, for enabling access by the host via the external cable to the first NVM array 701₁ via the first connection lane at USB 2.0 at 480 Mbps; a circuit/module 724₁ for controlling power (e.g., to provide full power to the subscript 1 components if CC1 is active but reduced power to the subscript 1 components if CC2 is instead active); a circuit/module 726₁ for controlling notifications sent to the host (as described above); and a circuit/module 728₁ for controlling the protocol for data transfer between the host and the first NVM array 701₁ based on the mating orientation (e.g., for providing USB 10 Gbps along lane 1 in the first mating configuration and USB 2.0 along lane 1 in the second mating configuration).

In at least some examples, means may be provided for performing the functions illustrated in FIG. 7 and/or other functions illustrated or described herein. For example, the means may include one or more of: means, such as circuit/module 720₁, for detecting plug insertion/disconnection via communication interface 702₁; means, such a circuit/module 722₁, for detecting plug orientation; means, such a circuit/module 724₁, for controlling power; means, such a circuit/module 726₁, for controlling notifications sent to the host; and means, such a circuit/module 728₁, for controlling the protocol for data transfer between the host and the first NVM array 701₁ based on the mating orientation (e.g., for providing USB 10 Gbps along lane 1 in the first mating configuration and USB 2.0 along lane 1 in the second mating configuration). In yet another aspect of the disclosure, a non-transitory computer-readable medium is provided that has one or more instructions which when executed by a processing circuit in an SSD causes the data storage controller of the SSD to perform one or more of the functions or operations listed above.

As noted, a second set of components is provided, which may be configured the same as the first set of components but which operate in accordance with USB 2.0 if the first set of components is operating in accordance with USB 10 Gbps, and operate in accordance with USB 10 Gbps if the first set of components is operating in accordance with USB 2.0. The second set of components will only briefly be described. A data processing controller 710₂ is communicatively coupled to a second NVM die array 701₂ that includes one or more memory dies 704₂, each of which may include physical memory arrays 706₂, e.g., NAND blocks. The apparatus 700 includes a second communication interface 702₂, e.g. a second communication lane, connected to the socket 703.

According to at least one example of the apparatus 700, the data processing controller 710₂ may include one or more of: a circuit/module 720₂ for detecting plug insertion/disconnection via communication interface 702₂; a circuit/module 722₂ for detecting plug orientation (by detecting, e.g., a CC1 connection instead of a CC2 connection) and, in response to a CC2 connection, for enabling access by a host via an external cable to the second NVM array 701₂ via the second connection lane at USB 10 Gbps, or, in response to a CC1 connection, for enabling access by the host via the external cable to the second NVM array 701₂ via the second connection lane at USB 2.0 at 480 Mbps; a circuit/module 724₂ for controlling power (e.g., to provide full power to the subscript 2 components if CC2 is active but reduced power to the subscript 2 components if CC1 is instead active); a circuit/module 726₂ for controlling notifications sent to the host (as described above); and a circuit/module 728₂ for controlling the protocol for data transfer between the host and the second NVM array 701₂ based on the mating orientation (e.g., for providing USB 10 Gbps along lane 2 in the second mating configuration and USB 2.0 along lane 2 in the first mating configuration).

According to at least one example of the apparatus 700, the processing controller 710₂ may include one or more of: means, such as circuit/module 720₂, for detecting plug insertion/disconnection via communication interface 702₂; means, such a circuit/module 722₂, for detecting plug orientation; means, such a circuit/module 724₂, for controlling power; means, such a circuit/module 726₂, for controlling notifications sent to the host; and means, such a circuit/module 728₂, for controlling the protocol for data transfer between the host and the first NVM array 701₂ based on the mating orientation (e.g., for providing USB 10 Gbps along lane 2 in the second mating configuration and USB 2.0 along lane 2 in the first mating configuration). In yet another aspect of the disclosure, a non-transitory computer-readable medium is provided that has one or more instructions which when executed by a processing circuit in an SSD causes the data storage controller of the SSD to perform one or more of the functions or operations listed above.

Still further, note that: circuit/modules 722₁ and 722₁ provide a means for detecting a connection of a second connector (e.g., a USB-C plug connector) with a first connector (e.g., a USB-C socket connector) in a first mating orientation. Circuit/module 728₁ provides a means, operative in response to detecting the connection of the second connector with the first connector in the first mating orientation, for enabling access by the host via an external cable to the first NVM array 704₁ under the control of the first data storage controller 710₁ with a first communication protocol. Circuit/module 728₂ provides means, also operative in response to detecting the connection of the second connector with the first connector in the first mating orientation, for enabling access by the host via the external cable to the second NVM array 704₂ under the control of the second data storage controller 710₂ with a second, different communication protocol. Circuit/modules 720₁ and 720₂ provide means for detecting a disconnection of the second connector from the first connector and, in response, for disabling access by the host to the first and second NVM arrays, respectively. Circuit/modules 722₁ and 722₁ provide means for detecting a connection of the second connector with the first connector in the second, different mating orientation with the first connector. Circuit/module 728₁ provides a means, operative in response to detecting the connection of the second connector with the first connector in the second mating orientation, for enabling access by the host via the external cable to the first NVM array 704₁ under the control of the first data storage controller 728₁ with the second communication protocol. Circuit/module 728₂ provides a means, operative in response to detecting the connection of the second connector with the first connector in the second mating orientation, for enabling concurrent access by the host via the external cable to the second NVM array 704₂ under the control of the second data storage controller 728₂ with the first communication protocol. In the first mating orientation, the first communication protocol may be USB 10 Gbps or higher and the second communication protocol may be USB 2.0. In the second mating orientation, the first communication protocol may be USB 2.0 and the second communication protocol may be USB 10 Gbps or higher.

### Additional Exemplary Embodiments

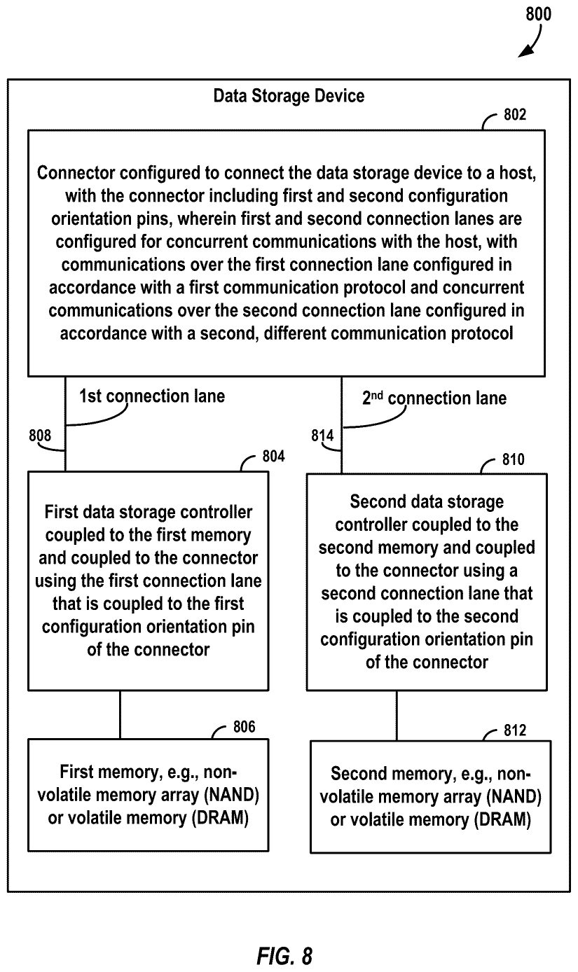

FIG. 8 is a block diagram of an exemplary data storage device 800 in accordance with some aspects of the disclosure. The data storage device 800 includes: a (first) connector 802 (such as a USB-C socket) configured to connect the data storage device to a host via an external (second) connector (such as a USB-C cable with a USB-C plug), with the connector 802 including first and second configuration orientation pins (e.g., CC1 and CC2). First and second connection lanes 808 and 814, respectively, are configured for concurrent communications with the host, with communications over the first connection lane configured in accordance with a first communication protocol and concurrent communications over the second connection lane configured in accordance with a second, different communication protocol. The data storage device 800 also includes: a first data storage controller 804 coupled to a first memory 806 (which may be an NVM such as a NAND or a volatile memory such as a DRAM) and coupled to the connector 802 using the first connection lane 808 that is coupled to the first configuration orientation pin (e.g., CC1) of the connector 802. The data storage device 800 also includes: a second data storage controller 810 coupled to a second memory 812 (which also may be an NVM such as a NAND or a volatile memory such as a DRAM) and coupled to the connector 802 using the second connection lane 814 that is coupled to the second configuration orientation pin (e.g., CC2) of the connector 802. Both of the connection lanes (808, 814) are communicatively coupled to the data storage device to the host via the connector 802 for concurrent communication, with communications over the first connection lane configured in accordance with a first communication protocol and concurrent communications over the second connection lane configured in accordance with a second, different communication protocol. In the first mating orientation, the first communication protocol may be USB 10 Gbps or higher and the second communication protocol may be USB 2.0. In the second mating orientation, the first communication protocol may be USB 2.0 and the second communication protocol may be USB 10 Gbps or higher. In other examples, the USB2.0 (480 Mbps) protocol instead could be USB1.1 (12 Mbps). Similarly, the 10 Gbps protocol could instead be 5 Gbps as well.

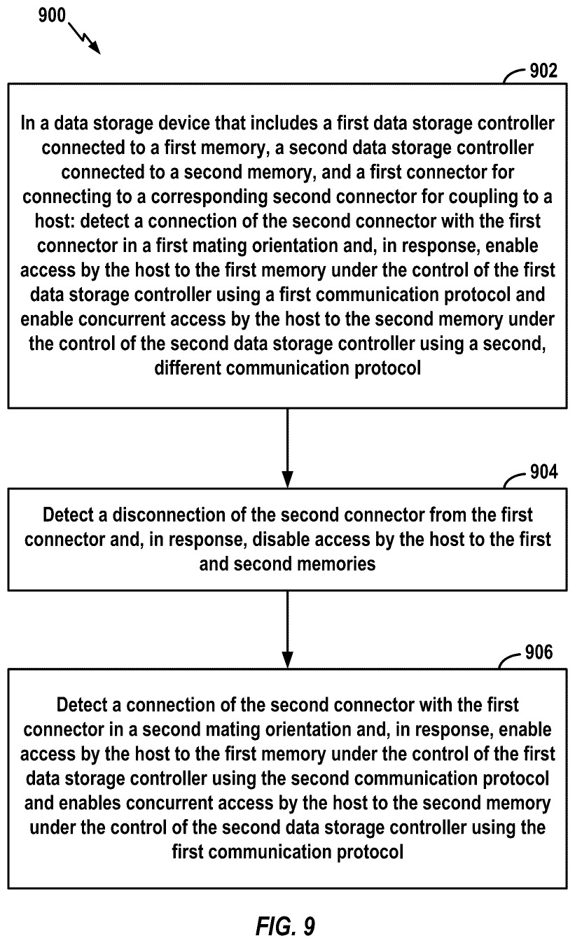

FIG. 9 illustrates a method or process 900 in accordance with some aspects of the disclosure for use by data storage device that includes a first data storage controller connected to a first memory, a second data storage controller connected to a second memory, and a first connector for connecting to a corresponding second connector coupled to a host. At block 902, the data storage device detects a connection of the second connector with the first connector in a first mating orientation and, in response, enables access by the host (e.g. via an external cable having the second connector) to the first memory under the control of the first data storage controller using a first communication protocol and enables concurrent access by the host (e.g., via the external cable) to the second memory under the control of the second data storage controller using a second, different communication protocol. At block 904, the data storage device detects disconnection of the second connector from the first connector and, in response, disables access by the host to the first and second memories. At block 906, the data storage device detects a connection of the second connector with the first connector in a second mating orientation and, in response, enables access by the host to the first memory under the control of the first data storage controller using the second communication protocol and enables concurrent access by the host to the second memory under the control of the second data storage controller using the first communication protocol. In the first mating orientation, the first communication protocol may be USB 10 Gbps or higher and the second communication protocol may be USB 2.0. In the second mating orientation, the first communication protocol may be USB 2.0 and the second communication protocol may be USB 10 Gbps or higher. In other examples, the USB2.0 (480 Mbps) protocol instead could be USB1.1 (12 Mbps). Similarly, the 10 Gbps protocol could instead be 5 Gbps as well.

In the following section, SSDs are described wherein two or more memory spaces are provided that have NAND dies of differing quality grades. For example, a first memory space can be formed of NANDs of prime quality for storing hot data, whereas a second memory space can be formed of NANDs of lower quality for storing cold data. The examples described below include a multiplexer (or similar device) for switching between the two memory spaces. It should be understood that the various SSD examples described above in connection with FIGS. 1-9 can also use NANDs of different quality grades in their respective memory spaces. By way of example, NANDS 1-4 of FIG. 3 can be of prime grade (e.g., Enterprise), whereas NANDS 5-8 of FIG. 3 can be of a lower grade (e.g., archival grade). Hence, the use of NAND dies of different quality grades is not limited only to the examples described below.

Exemplary SSD with Two NAND Memory Spaces with Different NAND Die Quality

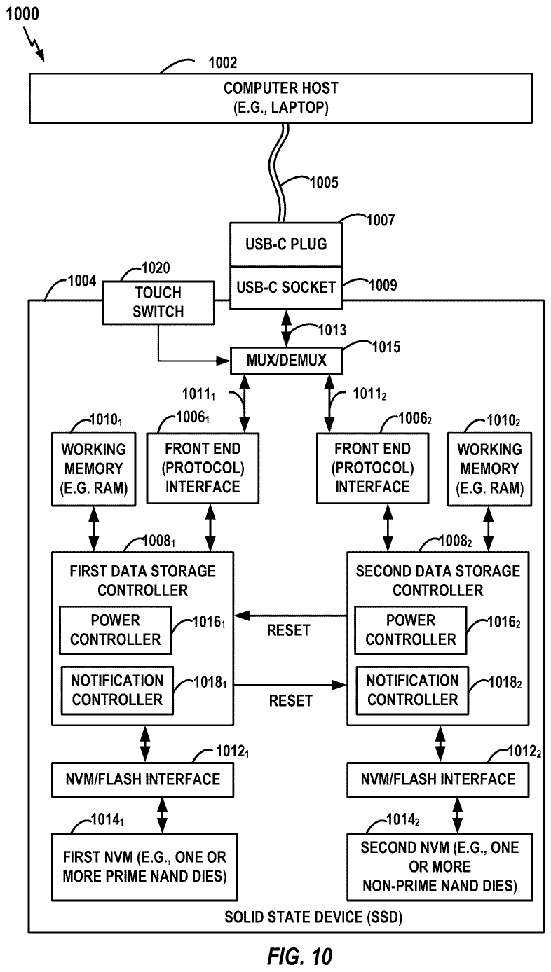

FIG. 10 is a block diagram of a system 1000 including an exemplary computer host 1002 (e.g., a laptop) and a solid state device (SSD) 1004 configured with two data storage controllers, two NVM arrays, and a multiplexer/demultiplexer (MUX/DEMUX) 1015. The first NVM array 1014₁ consists of prime NAND dies (e.g., high-quality Enterprise NAND dies). The second NVM array 1014₂ consists of non-prime NAND dies (e.g., lower-quality Archival NAND dies or binZZ dies). The host 1002 is connected to the SSD 1004 using an external USB-C connection cable 1005 having a USB connection plug 1007 for insertion into a USB-C connection socket 1009 in either of two mating orientations (as explained above). In other examples, other connection cables and connection protocols may be used. Note that the amount of memory provided with the prime grade NVM array 1014₁ may differ from the amount provided with the non-prime grade NVM array 1014₂. For example, the NVM array 1014₁ may provide 1 TB, whereas the NVM second array 1014₂ may provide 9 TB.

The SSD 1004 is configured to provide access to either the first NVM array (e.g., Partition A) or the second NVM array (e.g., Partition B) by the computer host 1002 depending upon the state of the MUX/DEMUX. For example, in a first MUX/DEMUX state, a first data storage controller 1008₁ and a first NVM array 1014₁ are communicatively coupled to the host 1002 using USB 10 Gbps. The host 1002 may provide a write command to the SSD 1004 for writing user data to NVM 1014₁ or a read command for reading user data from the NVM 1014₁, with access by the host 1002 to the NVM 1014₁ under the control of data storage controller 1008₁. In the second MUX/DEMUX state, the second data storage controller 1008₂ and the second NVM array 1014₂ are communicatively coupled to the host 1002 also using USB 10 Gbps. The host 1002 may provide a write command to the SSD 1004 for writing user data to NVM 1014₂ or a read command for reading user data from the NVM 1014₂, with access by the host 1002 to the NVM 1014₂ under the control of data storage controller 1008₂.

When the SSD 1004 first powers up, the SSD 1004 defaults to enabling the first data storage controller 1008₁ and a first NVM array 1014; with the MUX/DEMUX 1015 in the first state (e.g., Partition A is enabled). The second data storage controller 1008₂ and a second NVM array 1014₂ remain powered off. The host 1002 displays a drive indicator (e.g., F: drive) to the user showing the memory of the first NVM array 1014₁ to allow the user to store hot data the first NVM array 1014₁. Changes to the state of the MUX/DEMUX 1015 are controlled cither by a command (such as a vendor specific command) from the host 1002 or by a signal from an (optional) user control switch or button 1020 (such as a touch/capacitive sensor) on the external housing of the SSD 1104. For example, the OS of the host 1002 may be configured to prompt the user to switch from the first memory partition (e.g., Partition A) to the second memory partition (e.g. Partition B) associated with the second NVM array 1014₂ to, e.g., archive data.

If the user selects Partition B, a command is sent through the MUX/DEMUX 1015 to the first data storage controller 1008₁, which then controls the MUX/DEMUX 1015 to switch to the second state to connect the second NVM array 1014₂ to the host. A RESET signal is also sent from data storage controller 1008₁ to data storage controller 1008₂ to power up data storage controller 1008₂ and its NVM array 1014₂ to allow user access to that memory space. Partition B then appears as a drive (e.g., drive G:) in the OS of the host 1002 and the user has access to that memory space to, for example, archive cold data within the NVM array 1014₂. The data storage controller 1008₁ powers down (or, in some examples, the NVM array 1014₁ powers down while data storage controller 1008₁ continues to run).

Once data has been archived, the OS of the host 1002 prompts the user to switch from the second memory partition (e.g., Partition B) back to the first memory partition (e.g. Partition A). If the user selects Partition A, a command is sent through the MUX/DEMUX 1015 to the second data storage controller 1008₂, which controls the MUX/DEMUX 1015 to switch to the first state to connect the first NVM array 1014₁ to the host. A RESET signal is sent from data storage controller 1008₂ to data storage controller 1008₁ to power up data storage controller 1008₁ and its NVM array 1014₁ to again allow user access to the memory space of Partition A. Partition A appears as a drive (e.g., drive F:) in the OS of the host 1002 and the user has access again to that memory space. The data storage controller 1008₂ powers down (or, in some examples, the NVM array 1014₂ powers down while data storage controller 1008₂ continues to run). The ASICs of the data storage controllers 1008₁ and 1008₂ may have FW configured to coordinate processing with the MUX/DEMUX 1015 and with the other of the two data storage controllers using the RESET signals. The FW with the ASICs also manages the storage and retrieval of data to/from the respective NVM array of the data storage controller. It is noted that the ASIC FW used to store and retrieve data from a binZZ NAND die may be more complicated than the FW used to store and retrieve data from a prime grade NAND die because, for example, more sophisticated ECC may be required for use with a binZZ die.

In embodiments where a user touch switch 1020 is provided, the user can switch between the two partitions by pressing the switch (which may be, e.g., a capacitive switch). A signal is sent to the currently active data storage controller which, as already explained, then sends signals to the MUX/DEMUX 1015 and to the other of the two data storage controllers to power it up. Suitable notification signals are sent to the host to notify the host which partition is currently active so the appropriate drive indicator can be displayed to the user.

The SSD 1004 includes a front end (protocol) interface 1006₁ for interfacing with host 1002 via the USB-C-compatible protocol using a first connection lane 1011₁. The SSD 1004 also includes a working memory 1010₁ (such as RAM), an NVM interface 1012₁ (which may be referred to as a flash interface or backend interface), and the NVM 1014₁, such as one or more NVM NAND dies or NVM arrays. The data storage controller 1008₁ includes a power controller 1016₁ and a notification controller 1018₁. The notification controller 1018₁ notifies the host 1002 of the NVM 1014₁ that is accessible to the user. The SSD 1004 also includes a front end (protocol) interface 1006₂ for interfacing with host 1002 via the USB-C-compatible protocol using a second connection lane 1011₂. The connection lanes 1011₁ and 1011₂ are connected to an open drain selection (SEL) I/O of the MUX/DEMUX 1015 to avoid connection conflicts and shorts. The SSD 1004 also includes a working memory 1010₂ (such as RAM), an NVM interface 1012₂ (e.g., flash interface or backend interface), and the NVM 1014₂, such as one or more NVM NAND dies or NVM arrays. The data storage controller 1008₂ also includes a power controller 1016₂ and a notification controller 1018₂. Note that although the power controllers and notification controllers are shown as components of the data storage controllers, they may be implemented as separate components. Moreover, rather than having separate power controllers and notification controllers, as shown, a single power controller and/or single notification controller can instead be provided, i.e., as components that are separate from the data storage controllers.

In the primary examples herein, the host 1002 is a laptop computer. However, host 1002 may be any system or device needing data storage or retrieval and a compatible interface for communicating with the SSD 1004. For example, the host 1002 may be a computing device, a desktop computer, a personal computer, a portable computer, a workstation, a server, a personal digital assistant, a digital camera, an Internet of Things (IoT) device, or a mobile phone. Still further, in some examples, the host may be any other device accessible via USB-C or a similar communication interface having a reversible connection scheme.

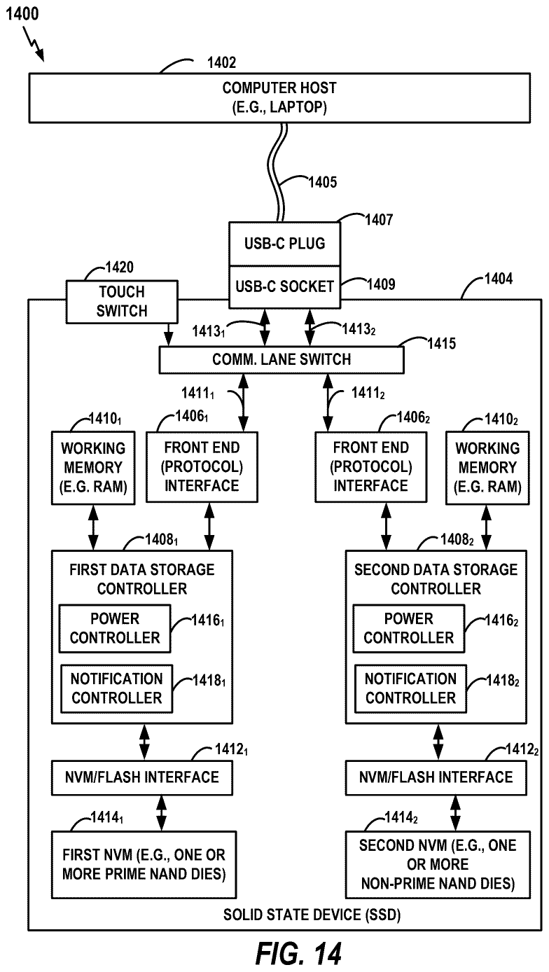

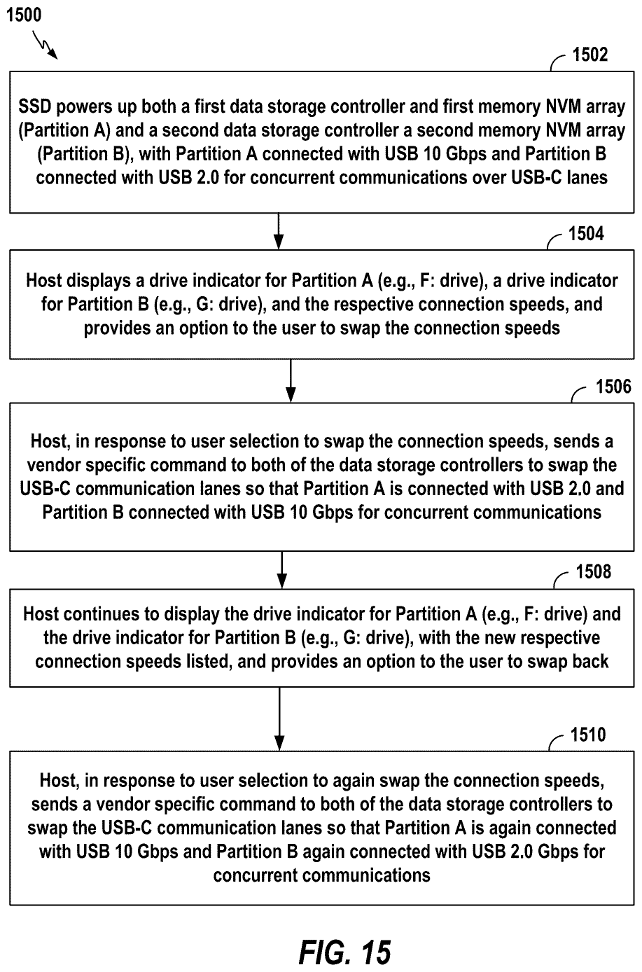

In the example of FIG. 10, cable 1005 provides a USB-C interface. In other examples, other suitable communication interfaces may be used. Since the embodiment of FIG. 10 does not need the concurrent communication described above (where one memory space is accessible at USB 10 Gbps while the other memory space is concurrently accessible using USB 2.0), the connection interface does not need a reversible cable. Hence, the SSD 1004 can be configured for use with a wide variety of interfaces or cables. Embodiments are described below with reference to FIGS. 14 and 15 where concurrent communication is provided and the user can selectively switch the communication lanes without flipping the USB-C connector.

Note that the data storage controllers 1008₁ and 1008₂ of FIG. 10 may include any type of processing device, such as a microprocessor, a microcontroller, an embedded controller, a logic circuit, software, firmware, or the like, for controlling the operation of the SSD 1004. In some aspects, some or all of the functions described herein as performed by one or both of the data storage controllers may instead be performed by another element of the SSD 1004. For example, the SSD 1004 may include a microprocessor, a microcontroller, an embedded controller, a logic circuit, software, firmware, or any kind of processing device, for performing one or more of the functions described herein as being performed by one or both of the data storage controllers.

The working memories 1010₁ and 1010₂ of FIG. 10 may be any suitable memory or system capable of storing data. For example, the memories may be ordinary RAM, DRAM, double data rate (DDR) RAM, static RAM (SRAM), synchronous dynamic RAM (SDRAM), flash storage, an erasable programmable read-only-memory (EPROM), an electrically erasable programmable ROM (EEPROM), or the like. In various embodiments, the data storage controllers use the working memories, or portions thereof, to store data during the transfer (transference) of data between the host 1002 and the NVMs. For example, the working memories or portions thereof may be a cache memory. The NVMs 1014₁ and 1014₂ may be any suitable type of non-volatile memory, such as a NAND-type flash memory or the like. In other embodiments, memories 1014₁ and 1014₂ could be volatile memories, with memory 1014₁ being a volatile memory (e.g., DRAM) of a prime quality grade and memory 1014₂ being a volatile memory (e.g., DRAM) of a lower quality grade. That is, one or more volatile memory dies may be used within the SSD 1004.

Although FIG. 10 shows an exemplary SSD that is configured as an SSD with flash NAND NVM, the various disclosed embodiments are not necessarily limited to an SSD application/implementation. The disclosed NVM dies and associated processing components can be implemented as part of a package that includes other processing circuitry and/or components. For example, a processor may include, or otherwise be coupled with, embedded NVM and associated circuitry and/or components. The processor could, as one example, offload certain tasks to the NVM and associated circuitry and/or components. Moreover, although FIG. 10 shows an SSD with a connection socket for receiving a connection plug, other embodiments of the SSD can be configured as a thumb drive with a connection plug for insertion into a connection socket of a host. Sec, above, for thumb drive configuration information.

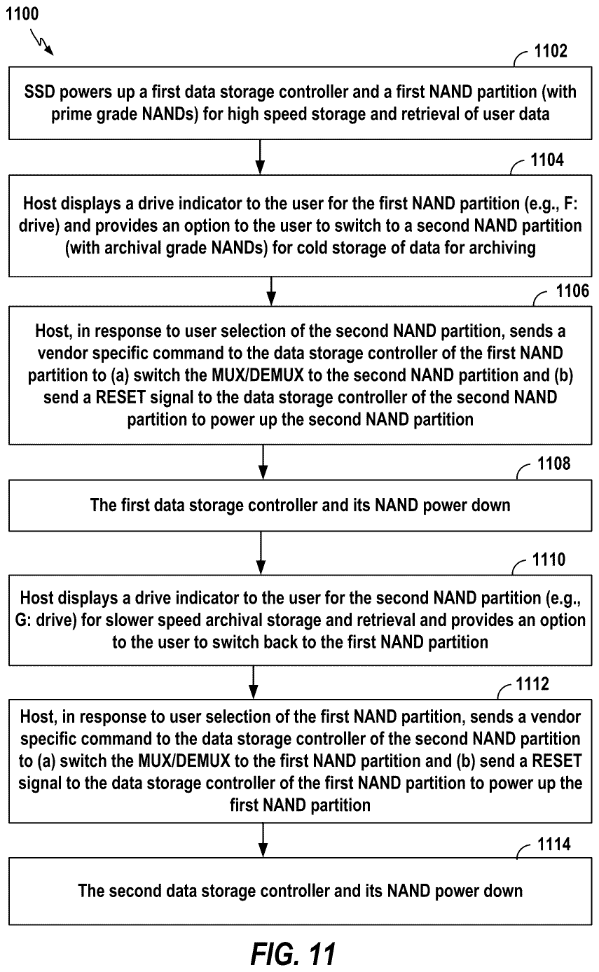

FIG. 11 is a flowchart 1100 summarizing aspects of the connection procedures of the system of FIG. 10. At 110₂, the SSD (e.g., SSD 1004 of FIG. 10) is turned on and powers up the first data storage controller and the first NAND partition (with prime grade NANDs) for high speed storage and retrieval of user data. At block 1004, the host (e.g., host 1002 of FIG. 10) displays a drive indicator to the user for the first NAND partition (e.g., F: drive) and provides an option to the user to switch to the second NAND partition (with archival grade NANDs) for cold storage of data for archiving. At block 1106, the host, in response to user selection of the second NAND partition, sends a command (which may be vendor specific) to the data storage controller of the first NAND partition to (a) switch the MUX/DEMUX to the second NAND partition and (b) send a RESET signal to the data storage controller of the second NAND partition to power up the second NAND partition. At block 1108, the first data storage controller and its NAND power down. At block 1110, the host displays a drive indicator to the user for second NAND partition (e.g., G: drive) for slower speed archival storage and retrieval and provides option to the user to switch back to the first NAND partition. At block 1112, the host, in response to user selection of the first NAND partition, sends a command (which may be vendor specific) to the data storage controller of the second NAND partition to (a) switch the MUX/DEMUX to the first NAND partition and (b) send a RESET signal to the data storage controller of the first NAND partition to power up the first NAND partition. At block 1114, the second data storage controller and its NAND power down. The process may continue with the user alternating between the two drive partitions.

Exemplary Hybrid SSD with Prime Quality NAND Dies and an HDD

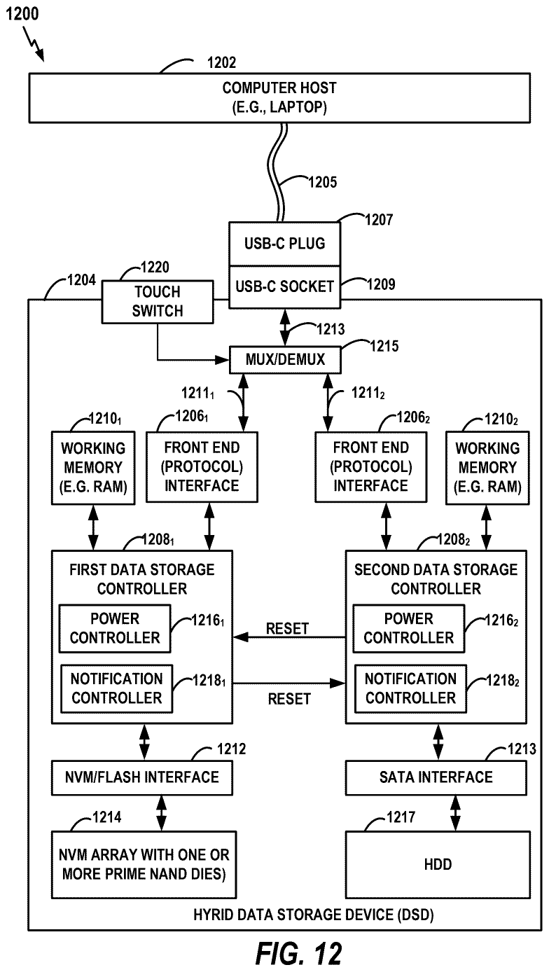

FIG. 12 is a block diagram of a system 1200 including an exemplary computer host 1202 (e.g., a laptop) and a hybrid data storage device (DSD) 1204 configured with two data storage controllers, a MUX/DEMUX 1215, an NVM array 1214, and an HDD 1217. The NVM array 1214 consists of prime NAND dies (e.g., high-quality Enterprise NAND dies). The HDD 1217 may be a multi-platter HDD. The host 1202 is connected to the DSD 1204 using an external USB-C connection cable 1205 having a USB connection plug 1207 for insertion into a USB-C connection socket 1209 in either of two mating orientations (as explained above). In other examples, other connection cables and connection protocols may be used.

The DSD 1204 is configured to provide access to either the NVM array (e.g., Partition A) or the HDD (e.g., Partition B) by the computer host 1202 depending upon the state of the MUX/DEMUX. For example, in a first MUX/DEMUX state, a first data storage controller 1208₁ and the NVM array 1214 are communicatively coupled to the host 1202 using USB 10 Gbps. The host 1202 may provide a write command to the DSD 1204 for writing user data to NVM 1214 or a read command for reading user data from the NVM 1214, with access by the host 1202 to the NVM 1214 under the control of data storage controller 1208₁. In the second MUX/DEMUX state, the second data storage controller 1208₂ and the HDD 1217 are communicatively coupled to the host 1202 also using USB 10 Gbps. The host 1202 may provide a write command to the DSD 1204 for writing user data to HDD 1217 or a read command for reading user data from the HDD 1217, with access by the host 1202 to the HDD 1217 under the control of data storage controller 1208₂.

When the DSD 1204 first powers up, the DSD 1204 defaults to enabling the first data storage controller 1208₁ and a NVM array 1214 with the MUX/DEMUX 1215 in the first state (e.g., Partition A is enabled). The second data storage controller 1208₂ and HDD 1217 remain powered off. The host 1202 displays a drive indicator (e.g., F: drive) to the user showing the memory of the NVM array 1214 to allow the user to store hot data within the NVM array 1214. Changes to the state of the MUX/DEMUX 1215 are controlled either by a command (such as a vendor specific command) from the host 1202 or by a signal from an (optional) switch or button 1220 (such as a touch/capacitive sensor) on the external housing of the DSD 1204. For example, the OS of the host 1202 may be configured to prompt a user to switch from the first memory partition (e.g., Partition A) to the second memory partition (e.g. Partition B) associated with the HDD 1217 to, e.g., archive data.

If the user selects Partition B, a command is sent through the MUX/DEMUX 1215 to the first data storage controller 1208₁, which then controls the MUX/DEMUX 1215 to switch to the second state to connect the HDD 1217 to the host. A RESET signal is also sent from data storage controller 1208₁ to data storage controller 1208₂ to power up data storage controller 1208₂ and HDD 1217 to allow user access to that memory space. Partition B then appears as a drive (e.g., drive G:) in the OS of the host 1202 and the user has access to that memory space to, for example, archive cold data within the HDD 1217. The data storage controller 1208₁ powers down (or, in some examples, the NVM array 1214 powers down while data storage controller 1208₁ continues to run).

Once data has been archived, the OS of the host 1202 prompts the user to switch from the second memory partition (e.g., Partition B) back to the first memory partition (e.g. Partition A). If the user selects Partition A, a command is sent through the MUX/DEMUX 1215 to the second data storage controller 1208₂, which controls the MUX/DEMUX 1215 to switch to the first state to connect the NVM array 1214 to the host. A RESET signal is sent from data storage controller 1208₂ to data storage controller 1208₁ to power up data storage controller 1208₁ and its NVM array 1214 to again allow user access to the memory space of Partition A. Partition A appears as a drive (e.g., drive F:) in the OS of the host 1202 and the user has access again to that memory space. The data storage controller 1208₂ powers down (or, in some examples, the HDD 1217 powers down while data storage controller 1208₂ continues to run). The ASICs of the data storage controllers 1208₁ and 1208₂ may have FW configured to coordinate processing with the MUX/DEMUX 1215 and with the other of the two data storage controllers using the RESET signals.

In embodiments where a touch switch 1220 is provided, the user can switch between the two partitions by pressing the switch (which may be, e.g., a capacitive switch). A signal is sent to the currently active data storage controller which, as already explained, then sends signals to the MUX/DEMUX 1215 and to the other of the two data storage controllers to power it up. Suitable notification signals are sent to the host to notify the host which partition is currently active so the appropriate drive indicator can be displayed to the user.

The DSD 1204 includes a front end (protocol) interface 1206₁ for interfacing with host 1202 via the USB-C-compatible protocol using a first connection lane 1211₁. The DSD 1204 also includes a working memory 1210₁ (such as RAM), an NVM interface 1212 (which may be referred to as a flash interface or backend interface), and the NVM 1214, such as one or more NVM NAND dies or NVM arrays. The data storage controller 1208₁ includes a power controller 1216₁ and a notification controller 1218₁. The notification controller 1218₁ notifies the host 1202 of the NVM 1214 that is accessible to the user. The DSD 1204 also includes a front end (protocol) interface 1206₂ for interfacing with host 1202 via the USB-C-compatible protocol using a second connection lane 1211₂. The connection lanes 1211₁ and 1211₂ are connected to an open drain selection (SEL) I/O of the MUX/DEMUX 1215 to avoid connection conflicts and shorts. The DSD 1204 also includes a working memory 1210₂ (such as RAM), a SATA interface 1213, and the HDD 1217. The second data storage controller 1208₂ may be a USB-to-SATA bridge. The data storage controller 1208₂ also includes a power controller 1216₂ and a notification controller 1218₂. Note that although the power controllers and notification controllers are shown as components of the data storage controllers, they may be implemented as separate components. Moreover, rather than having separate power controllers and notification controllers, as shown, a single power controller and/or single notification controller can instead be provided, i.e., as components that are separate from the data storage controllers.

In the example of FIG. 12, cable 1205 provides a USB-C interface. In other examples, other suitable communication interfaces may be used. Since the embodiment of FIG. 12 does not need the concurrent communication described above (where one memory space is accessible at USB 10 Gbps while the other memory space is concurrently accessible using USB 2.0), the connection interface does not need a reversible cable. Hence, the DSD 1204 can be configured for use with a wide variety of interfaces or cables. Sec, the embodiments described below with reference to FIGS. 14 and 15 where concurrent communication is exploited using a USB-C connector.

As with the data storage controllers of FIG. 10, the data storage controllers 1208₁ and 1208₂ of FIG. 12 may include any type of processing device, such as a microprocessor, a microcontroller, an embedded controller, a logic circuit, software, firmware, or the like, for controlling the operation of the DSD 1204. In some aspects, some or all of the functions described herein as performed by one or both of the data storage controllers may instead be performed by another element of the DSD 1204. For example, the DSD 1204 may include a microprocessor, a microcontroller, an embedded controller, a logic circuit, software, firmware, or any kind of processing device, for performing one or more of the functions described herein as being performed by one or both of the data storage controllers.

As with the working memories of FIG. 10, the working memories 1210₁ and 1210₂ of FIG. 12 may be any suitable memory or system capable of storing data. For example, the memories may be ordinary RAM, DRAM, DDR RAM, SRAM, SDRAM, flash storage, EPROM, EEPROM, or the like. In various embodiments, the data storage controllers use the working memories, or portions thereof, to store data during the transfer (transference) of data between the host 1202 and the NVM array or HDD. For example, the working memories or portions thereof may be a cache memory.

Although FIG. 12 shows an exemplary DSD, the various disclosed embodiments are not necessarily limited to a DSD application/implementation. The disclosed memories and associated processing components can be implemented as part of a package that includes other processing circuitry and/or components. For example, a processor may include, or otherwise be coupled with, embedded NVM and associated circuitry and/or components. The processor could, as one example, offload certain tasks to the NVM or HDD and associated circuitry and/or components. Moreover, although FIG. 12 shows a DSD with a connection socket for receiving a connection plug, other embodiments of the DSD can be configured as a thumb drive with a connection plug for insertion into a connection socket of a host. Sec, above, for thumb drive configuration information.

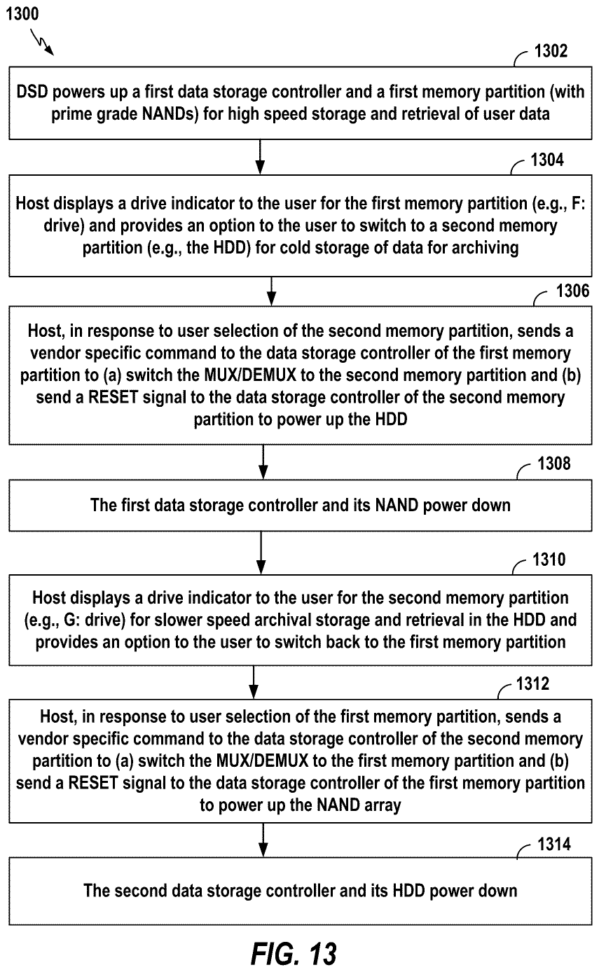

FIG. 13 is a flowchart 1300 summarizing aspects of the connection procedures of the system of FIG. 12. At 1302, the DSD (e.g., DSD 1204 of FIG. 12) is turned on and powers up the first data storage controller and the NVM array (with its prime grade NANDs) for high speed storage and retrieval of user data. At block 1304, the host (e.g., host 1202 of FIG. 12) displays a drive indicator to the user for the first memory partition (e.g., F: drive) and provides an option to the user to switch to the second memory partition (e.g., the HDD) for cold storage of archival data. At block 1306, the host, in response to user selection of the second memory partition, sends a command (which may be vendor specific) to the data storage controller of the first memory partition to (a) switch the MUX/DEMUX to the second memory partition and (b) send a RESET signal to the data storage controller of the second memory partition to power up the HDD. At block 1308, the first data storage controller and its NVM array power down. At block 1310, the host displays a drive indicator to the user for the second memory partition (e.g., G: drive) for slower speed archival storage and retrieval and provides an option to the user to switch back to the first memory partition. At block 1312, the host, in response to user selection of the first memory partition, sends a command (which may be vendor specific) to the data storage controller of the second memory partition to (a) switch the MUX/DEMUX to the first memory partition and (b) send a RESET signal to the data storage controller of the first memory partition to power up the NVM array. At block 1314, the second data storage controller and its HDD power down. The process may continue with the user alternating between the two drive partitions.

Exemplary SSD with Two Memory Spaces and Communication Lane Switching

FIG. 14 is a block diagram of a system 1400 including an exemplary computer host 1402 (e.g., a laptop) and a solid state device (SSD) 1404 configured with two data storage controllers and two NVM arrays to provide two memory partitions. The SSD 1404 is configured for concurrent communication using both USB 10 Gbps and USB 2.0 via a USB-C connector. A communication lane switch 1415 enables a user to select which memory partition is connected to the host via the USB 10 Gbps lane and which is connected via the slower USB 2.0 lane. The user may select the configuration using a touch switch on the external housing of the SSD. Additionally or alternatively, the user may may select the communication lane configuration via commands entered into the host 1402, which are then sent to the SSD. The user need not physically remove the connector plug and reinsert the plug to change which memory partition is connected via USB 10 Gbps and which is connected via USB 2.0.

In the example of FIG. 14, the first memory partition (e.g., Partition A) is an NVM array with prime grade NAND dies, whereas the second memory partition (e.g., Partition B) is an NVM array with non-prime grade NAND dies (e.g., BinZZ dies). However, in other embodiments, the two memory partitions can both have the same quality grade of NAND dies (e.g., both can be prime dies or both can be archival BinZZ grades dies). In still other embodiments, the storage device can be a hybrid drive where one of the memory partitions is an NVM array with NAND dies and the other memory partition is an HDD. (When the storage device is configured as a hybrid drive with an HDD, the device is more properly referred to as a DSD rather than an SSD. However, for the purposes of describing the embodiment illustrated in FIG. 14, the term SSD will be used since both partitions use NVM arrays with NAND dics.)

In the example of FIG. 14, the first NVM array 1414₁ consists of prime NAND dies (e.g., high-quality Enterprise NAND dies). The second NVM array 1414₂ consists of non-prime NAND dies (e.g., lower-quality Archival dies suitable for slower speed storage, such as binZZ dies). The host 1402 is connected to the SSD 1404 using an external USB-C connection cable 1405 having a USB connection plug 1407 for insertion into a USB-C connection socket 1409 in either of two mating orientations (as explained above).

The SSD 1404 is configured to provide concurrent access to both the first NVM array (e.g., Partition A) and the second NVM array (e.g., Partition B) by the computer host 1402 via the procedures described above in connection with FIGS. 3-9. Briefly, the CC pins (CC1 and CC2, not shown in FIG. 14, but see FIG. 3) of the USB-C connector socket 1409 are used by the host 1402 and the SSD 1404 to detect the orientation of the USB-C connector plug to enable a particular lane for 10 Gbps communication (i.e., lane 1412₁ or 1413₂) while the other lane is enabled for concurrent 480 Mbps communication using USB 2.0. When the USB-C plug is inserted, only one of the two CC pins in the USB-C socket is electrically connected to the host. If CC1 is electrically connected, the first communication (connection) lane 1413₁ is enabled for USB 10 Gbps and the first NVM array 1414₁ is accessible to the host at that speed, while the other communication (connection) lane 1413₂ is enabled for USB 2.0. NVM array 1414₂ is accessible to the host at the slower speed of 480 Mbps. Note that the USB2.0 (480 Mbps) lane/protocol could also be USB1.1 (12 Mbps). That is, USB2.0/1.1. Similarly, the 10 Gbps could instead be 5 Gbps. That is, the USB 2.0/USB 10 Gbps configuration is just one example.

When the SSD 1404 first powers up, the SSD 1404 enables both the first data storage controller 1408₁ and the first NVM array 1414₁ (e.g., Partition A) and the second data storage controller 1408₂ and the second NVM array 1414₂ (e.g., Partition B). By default, the communication lane switch 1415 is in a first state that enables USB 10 Gbps communications with the host 1402 using Partition A via communication lane 1413₁ and enables concurrent USB 2.0 480 Mbps communications with the host 1402 using Partition B via communication lane 1413₂. The host 1402 displays a separate drive indicator for the two partitions (e.g., F: drive and G: drive) and displays the corresponding connection speed. The host also informs the user that he or she can swap the connection speeds, which is controlled either by a command (such as a vendor specific command) sent from the host 1402 to the SSD 1404 or by a signal from an (optional) switch or button 1420 on the external housing of the SSD 1404.

If the user wants to swap the connection speeds, a command is sent from the host 1402 to both the first data storage controller 1408₁ and second data storage controller 1408₂, which then control the communication lane switch 1415 to swap the communication lanes to: route communications from data storage controller 1408₁ and NVM array 1414₁ (e.g., Partition A) along communication lane 1413₂; and concurrently route communications from data storage controller 1408₂ and NVM array 1414₂ (e.g., Partition B) along communication lane 1413₁. The ASICs of the data storage controllers 1408₁ and 1408₂ may have FW configured to coordinate processing with the communication lane switch 1415.

Later, if the user wants to swap the connection speeds back to the original default configuration, another command is sent from the host to both the first data storage controller 1408₁ and second data storage controller 1408₂, which then control the communication lane switch 1415 to swap the communication lanes to: route communications from data storage controller 1408₁ and NVM array 1414₁ (e.g., Partition A) along communication lane 1413₁; and concurrently route communications from data storage controller 1408₂ and NVM array 1414₂ (e.g., Partition B) along communication lane 1413₂.

In embodiments where a touch switch 1420 is provided, the user can swap the communication speeds by pressing the switch (which may be, e.g., a capacitive switch). A signal is sent to the communication lane switch and the two data storage controllers which, as already explained, operate to swap the connection lanes. Suitable notification signals are sent to the host to notify the host which memory partition is currently connected to which lane so the appropriate information can be displayed to the user. Alternatively, the user could flip the USB-C connector plug and then re-insert it into the socket, but this would disconnect the SSD drive from the host, requiring the host to then regain communications with the SSD.

The SSD 1404 includes a front end (protocol) interface 1406₁ for interfacing with host 1402 via the USB-C-compatible protocol using a first communication (connection) lane 1411₁. The SSD 1404 also includes a working memory 1410₁ (such as RAM), an NVM interface 1412₁ (which may be referred to as a flash interface or backend interface), and the NVM 1414₁, such as one or more NVM NAND dies or NVM arrays. The data storage controller 1408₁ includes a power controller 1416₁ and a notification controller 1418₁. The notification controller 1418₁ notifies the host 1402 of the NVM 1414₁ that is accessible to the user. The SSD 1404 also includes a front end (protocol) interface 1406₂ for interfacing with host 1402 via the USB-C-compatible protocol using a second communication (connection) lane 1411₂. The SSD 1404 also includes a working memory 1410₂ (such as RAM), an NVM interface 1412₂ (e.g., flash interface or backend interface), and the NVM 1414₂, such as one or more NVM NAND dies or NVM arrays. The data storage controller 1408₂ also includes a power controller 1416₂ and a notification controller 1418₂. Note that although the power controllers and notification controllers are shown as components of the data storage controllers, they may be implemented as separate components. Moreover, rather than having separate power controllers and notification controllers, as shown, a single power controller and/or single notification controller can instead be provided, i.e., as components that are separate from the data storage controllers.

In the primary examples herein, the host 1402 is a laptop computer. However, host 1402 may be any system or device needing data storage or retrieval and a compatible interface for communicating with the SSD 1404. For example, the host 1402 may be a computing device, a desktop computer, a personal computer, a portable computer, a workstation, a server, a personal digital assistant, a digital camera, an Internet of Things (IoT) device, or a mobile phone. Still further, in some examples, the host may be any other device accessible via USB-C or a similar communication interface having a reversible connection scheme.

Note that the data storage controllers 1408₁ and 1408₂ of FIG. 14 may include any type of processing device, such as a microprocessor, a microcontroller, an embedded controller, a logic circuit, software, firmware, or the like, for controlling the operation of the SSD 1404. In some aspects, some or all of the functions described herein as performed by one or both of the data storage controllers may instead be performed by another element of the SSD 1404. For example, the SSD 1404 may include a microprocessor, a microcontroller, an embedded controller, a logic circuit, software, firmware, or any kind of processing device, for performing one or more of the functions described herein as being performed by one or both of the data storage controllers.

The working memories 1410₁ and 1410₂ of FIG. 14 may be any suitable memory or system capable of storing data. For example, the memories may be ordinary RAM, DRAM, DDR RAM, SRAM, SDRAM, flash storage, EPROM, EEPROM, or the like. In various embodiments, the data storage controllers use the working memories, or portions thereof, to store data during the transfer (transference) of data between the host 1402 and the NVMs. For example, the working memories or portions thereof may be a cache memory. The NVMs 1414₁ and 1414₂ may be any suitable type of non-volatile memory, such as a NAND-type flash memory or the like.

Although FIG. 14 shows an exemplary SSD that is configured as an SSD with flash NAND NVM, the various disclosed embodiments are not necessarily limited to an SSD application/implementation. The disclosed NVM dies and associated processing components can be implemented as part of a package that includes other processing circuitry and/or components. For example, a processor may include, or otherwise be coupled with, embedded NVM and associated circuitry and/or components. The processor could, as one example, offload certain tasks to the NVM and associated circuitry and/or components. Moreover, although FIG. 14 shows an SSD with a connection socket for receiving a connection plug, other embodiments of the SSD can be configured as a thumb drive with a connection plug for insertion into a connection socket of a host. Sec, above, for thumb drive configuration information.

FIG. 15 is a flowchart 1500 summarizing aspects of the connection procedures of the system of FIG. 14. At 1502, the SSD (e.g., SSD 1404 of FIG. 14) is turned on and powers up both the first data storage controller and first memory NVM array (Partition A) and the second data storage controller and second memory NVM array (Partition B) with Partition A connected with USB 10 Gbps and Partition B connected with USB 2.0 for concurrent communications with USB-C. At block 1404, the host (e.g., host 1402 of FIG. 14) displays a drive indicator for Partition A (e.g., F: drive), a drive indicator for Partition B (e.g., G: drive), and the respective connection speeds for the two drives (e.g., 10 Gbps for drive F; and 480 Mbps for drive G:) and provides an option to the user to swap the connection speeds. At block 1506, the host, in response to user selection to swap the connection speeds, sends a command (which may be vendor specific) to both data storage controllers to swap the USB-C communication lanes so that Partition A is then connected with USB 2.0 and Partition B connected with USB 10 Gbps for concurrent communications. At block 1508, the host continues to display the drive indicator for Partition A (e.g., F: drive) and the drive indicator for Partition B (e.g., G: drive), with the new respective connection speeds listed (e.g., 480 Mbps for drive F; and 10 Gbps for drive G:), and provides an option to the user to swap back. At block 1510, the host, in response to user selection to again swap the connection speeds, sends a command (which may be vendor specific) to both data storage controllers to swap the USB-C communication lanes so that Partition A is once again connected with USB 10 Gbps and Partition B is once again connected with USB 2.0 Gbps for concurrent communications. The process may continue with the user swapping the connection speeds as desired.

Exemplary SSD with Two Memory Spaces and External Housing Alignment Indicia

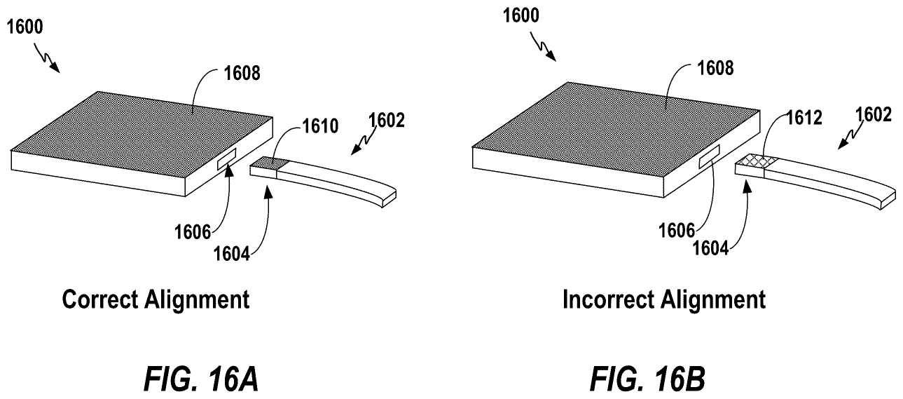

FIG. 16A is a perspective view of a flippable external drive (e.g., SSD or DSD) 1600 and a symmetric (reversible) connection cable 1602, such as a USB-C cable. The connection cable has a plug 1604 for insertion into a slot 1606 of the external drive 1600 in one of two orientations. Opposing sides of the drive 1600 have different indicia such as colors, patterns, or other markings. Likewise, opposing sides of the plug 1604 have different indicia, which match the indicia of the drive when the plug 1604 is inserted into the slot 1606 is a correct or preferred orientation. As shown in FIG. 16, the top surface 1608 of the drive 1600 has a pattern that matches a corresponding pattern on the top surface 1610 of plug 1604.

FIG. 16B is a perspective view of the same external drive (e.g., SSD or DSD) 1600 and the same symmetric (reversible) connection cable 1602. However, within FIG. 16B, the orientation of the cable 1602 is reversed so that its plug 1604 shows the opposing side 1612, which has a pattern that does not match the pattern on side 1608 of the drive 1600, indicating an incorrect alignment. Although not shown in the figures, the opposing (bottom) side of the drive 1600 has a pattern that matches the pattern of side 1612 of plug 1604 so that if the drive were flipped upside down, its pattern would match the pattern of side 1612 of plug 1604.

Rather than using different patterns, different colors may be employed. For example, one side of the drive and one side of the plug may be colored black, whereas the opposing sides of the drive and the plug may be colored pink. In some examples, text might be provided such as matching words or matching symbols.

The use of matching indicia on both the drive and the plug of the connection cable make it easy for a user to insert the plug into the slot of the drive in a correct of preferred orientation. This feature is perhaps most advantageously employed with flippable eternal drives that do not have switches or multiplexers of the type described above that allow a user to casily switch between two memory spaces or between two communication protocols. For example, if a drive has a high-speed prime grade NAND memory space that is only accessible with a high speed connection protocol if the connection plug is inserted with a certain orientation, then the indicia enable the user to easily see which way the plug should be inserted.

For external drives that have switching mechanisms that allow the user to switch memory spaces or swap communication protocols, the matching indicia can still be advantageous to enable the user to at least see an initial preferred orientation. In the embodiment of FIG. 14, it may be preferrable for the user to initially insert the plug into the external drive in an orientation that connects the prime grade memory space to the host using the USB 10 Gbps protocol and connects the other archival memory space using the slower USB 2.0 connection. That way, no switching is required as might otherwise be needed if the plug were initially inserted with the prime grade memory space connected to the host using the USB 2.0 protocol and the archival memory space connected using USB 10 Gbps connection.

### Further Exemplary Embodiments

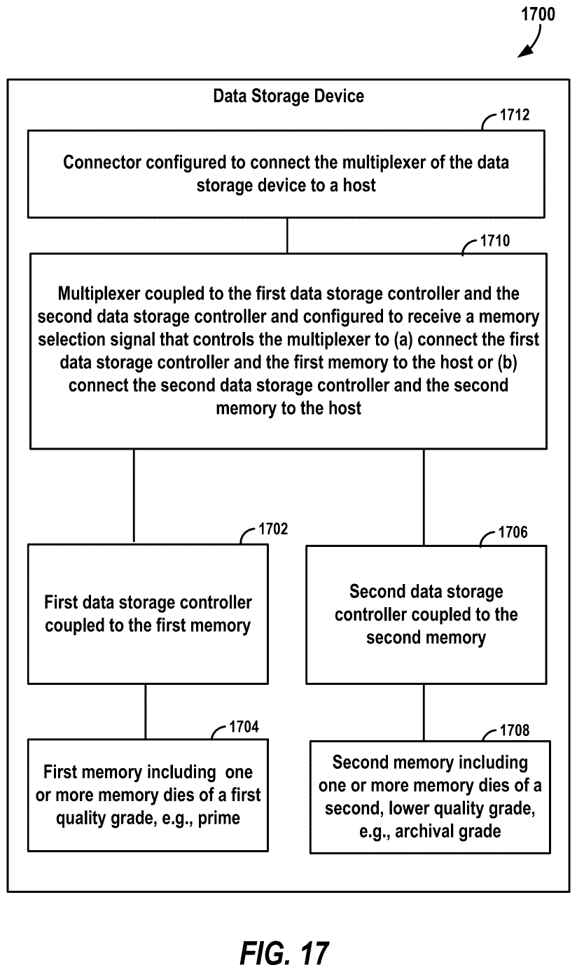

FIG. 17 is a block diagram of an exemplary data storage device 1700 in accordance with some aspects of the disclosure. The data storage device 1700 includes a first data storage controller 1702 coupled to a first memory 1704, wherein the first memory includes one or more memory dies of a first quality grade, e.g., a prime quality grade. A second data storage controller 1706 is coupled to a second memory 1708, wherein the second memory includes one or more memory dies of a second, lower quality grade, e.g., an archival quality grade. The first and second memories can be NVM dies with different quality grades. Alternatively, the first and second memories can be volatile memories (e.g. DRAMs) with different quality grades. A multiplexer 1710 is coupled to the first data storage controller and the second data storage controller and to a connector 1712 that is configured to connect the multiplexer to a host. The multiplexer is 1710 is configured to receive a memory selection signal that controls the multiplexer 1710 to either (a) connect the first data storage controller 1702 and the first memory 1704 to the host or instead (b) connect the second data storage controller 1706 and the second memory 1708 to the host through the multiplexer. In other words, based on a memory selection signal, the multiplexer 1710 is configured to either (a) connect the first data storage controller 1702 and the first memory 1704 to the host or instead (b) connect the second data storage controller 1706 and the second memory 1708 to the host through the multiplexer. The multiplexer 1710 may be configured to receive the memory selection signal from whichever one of the first and second data storage controllers 1702, 1706 is currently active. Alternatively, a control switch (not shown in FIG. 1700) may be provided on an external housing of the data storage device 1700, wherein the multiplexer 1710 is configured to receive the memory selection signal from the control switch.

In some aspects, the first data storage controller 1702 of FIG. 17 provides a means for controlling a first memory that includes one or more memory dies of a first quality grade, and the second data storage controller 1706 provides a means for controlling a second memory that includes one or more memory dies of a second, lower quality grade. The multiplexer 17010 provides a means for multiplexing between (a) connecting the first data storage controller and the first memory to a host or (b) connecting the second data storage controller and the second memory to the host. The connector 1712 provides a means for connecting the means for multiplexing to a host.

A method may be provided for use with the device of FIG. 17. The method may include: receiving a memory selection signal that indicates either a first memory of the data storage device or a second memory of the data storage device; connecting the first memory to a host through a first data storage controller, in response to the memory selection signal indicating the first memory, wherein the first memory includes one or more memory dies of a first quality grade, e.g., a prime quality grade; and connecting the second memory to the host through a second data storage controller, in response to the memory selection signal indicating the second memory, wherein the second memory includes one or more memory dies of a second quality grade that is lower than the first quality grade, e.g., an archival quality grade. The method may further include: sending a signal from the first data storage controller to the second data storage controller to deactivate the second data storage controller while the first data storage controller is connected to the host though the multiplexer; and sending a signal from the second data storage to the first data storage controller to deactivate the first data storage controller while the second data storage controller is connected to the host though the multiplexer. The memory selection signal may be received from a control switch on an external housing of the data storage device or from a currently active one of the first and second data storage controllers.

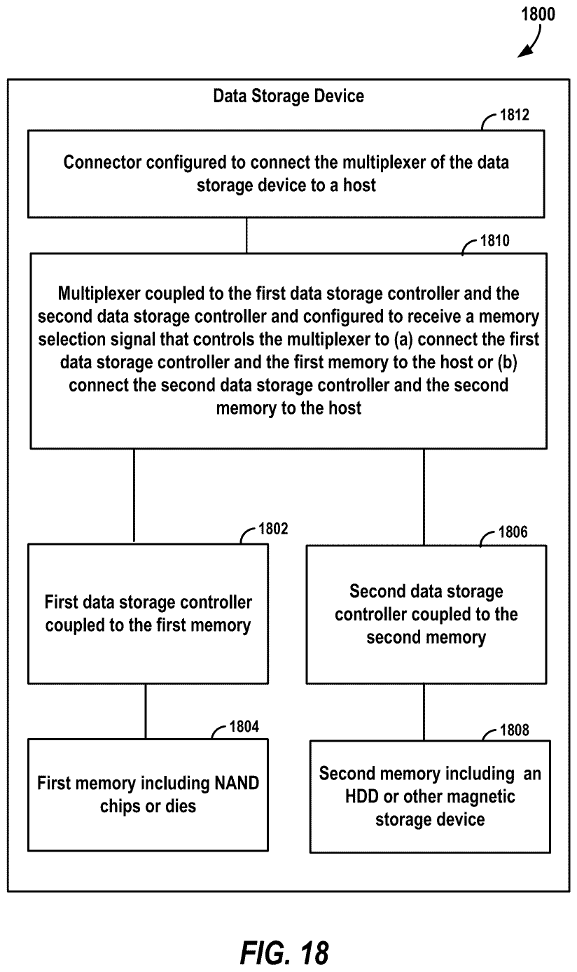

FIG. 18 is a block diagram of an exemplary data storage device 1800 in accordance with some aspects of the disclosure. The data storage device 1800 includes a first data storage controller 1802 coupled to a first memory 1804, wherein the first memory includes one or more NAND dies or chips. A second data storage controller 1806 is coupled to a second memory 1808, wherein the second memory includes an HDD or other magnetic storage device. A multiplexer 1810 is coupled to the first data storage controller and the second data storage controller and to a connector 1812 that is configured to connect the multiplexer to a host. The multiplexer is 1810 is configured to receive a memory selection signal that controls the multiplexer 1810 to either (a) connect the first data storage controller 1802 and the first memory 1804 to the host or instead (b) connect the second data storage controller 1806 and the second memory 1808 to the host through the multiplexer. In other words, based on a memory selection signal, the multiplexer 1810 is configured to either (a) connect the first data storage controller 1802 and the first memory 1804 to the host or instead (b) connect the second data storage controller 1806 and the second memory 1808 to the host through the multiplexer. The multiplexer 1810 may be configured to receive the memory selection signal from whichever one of the first and second data storage controllers 1802, 1806 is currently active. Alternatively, a control switch (not shown in FIG. 1800) may be provided on an external housing of the data storage device 1800, wherein the multiplexer 1810 is configured to receive the memory selection signal from the control switch.

In some aspects, the first data storage controller 1802 of FIG. 18 provides a means for controlling a first memory and its NAND dies or chips, and the second data storage controller 1806 provides a means for controlling a second memory and its HDD. The multiplexer 18010 provides a means for multiplexing between (a) connecting the first data storage controller and the first memory and its NAND to a host or (b) connecting the second data storage controller and the second memory and its HDD to the host. The connector 1812 provides a means for connecting the means for multiplexing to a host.

A method may be provided for use with the device of FIG. 18. The method may include: receiving a memory selection signal that indicates either a first memory of the data storage device, wherein the first memory includes NAND dies of chips, or a second memory of the data storage device, wherein the second memory includes an HDD; connecting the first memory to a host through a first data storage controller, in response to the memory selection signal indicating the first memory and connecting the second memory to the host through a second data storage controller, in response to the memory selection signal indicating the second memory. The method may further include: sending a signal from the first data storage controller to the second data storage controller to deactivate the second data storage controller while the first data storage controller is connected to the host though the multiplexer; and sending a signal from the second data storage to the first data storage controller to deactivate the first data storage controller while the second data storage controller is connected to the host though the multiplexer. The memory selection signal may be received from a control switch on an external housing of the data storage device or from a currently active one of the first and second data storage controllers.

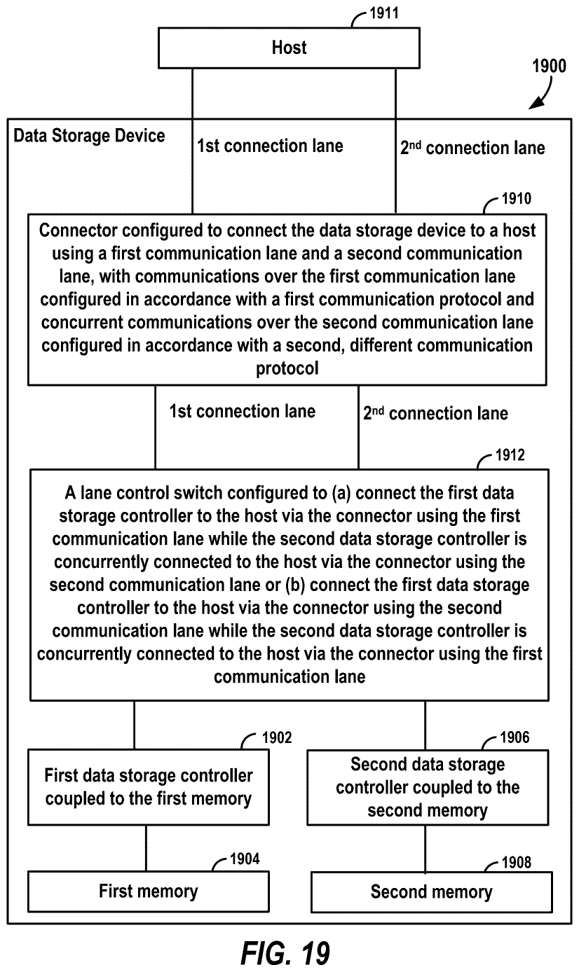

FIG. 19 is a block diagram of an exemplary data storage device 1900 in accordance with some aspects of the disclosure. The data storage device 1900 includes a first data storage controller 1902 coupled to a first memory 1904. A second data storage controller 1906 is coupled to a second memory 1908. A connector 1910 is configured to connect the data storage device to a host 1911 using a first communication lane and a second communication lane, with communications over the first communication lane configured in accordance with a first communication protocol and concurrent communications over the second communication lane configured in accordance with a second, different communication protocol. A lane control switch 1912 is configured to (a) connect the first data storage controller 1902 to the host using the first communication lane while the second data storage controller 1906 is concurrently connected to the host using the second communication lane or (b) connect the first data storage controller 1902 to the host using the second communication lane while the second data storage controller 1906 is concurrently connected to the host using the first communication lane.

In some aspects, the first data storage controller 1902 of FIG. 19 provides a means for controlling a first memory, and the second data storage controller 1906 provides a means for controlling a second memory. The connector 1910 provides a means for connecting the data storage device to a host using a first communication lane and a second communication lane, with communications over the first communication lane configured in accordance with a first communication protocol and concurrent communications over the second communication lane configured in accordance with a second, different communication protocol. The lane control switch 1912 provides a means for (a) connecting the means for controlling a first memory to the host using the first communication lane while the means for controlling a second memory is concurrently connected to the host using the second communication lane or (b) connecting the means for controlling the first memory to the host using the second communication lane while the means for controlling the second memory is concurrently connected to the host using the first communication lane.

A method may be provided for use with the device of FIG. 19. The method may include: receiving a communication lane selection signal indicating either a first connection state or a second connection state; connecting, in response to the communication lane selection signal indicating the first connection state, the first memory to a host via a first communication lane in accordance with a first communication protocol and connecting the second memory to the host via a second communication lane in accordance with a second, different communication protocol; and connecting, in response to the communication lane selection signal indicating the second connection state, the first memory to the host via the second communication lane in accordance with the second communication protocol and connecting the second memory to the host via the first communication lane in accordance with the first communication protocol. In some aspects, the communication lane selection signal is generated by a control switch on an external housing of the data storage device in response to user input or is received from the host. The first communication protocol may be, e.g., USB 10 Gbps or higher and the second communication protocol may be USB 2.0.

### Additional Aspects

Aspects of the subject matter described herein can be implemented in any suitable NAND flash memory, such as 3D NAND flash memory. Semiconductor memory devices include volatile memory devices, such as DRAM) or SRAM devices, NVM devices, such as ReRAM, EEPROM, flash memory (which can also be considered a subset of EEPROM), ferroelectric random access memory (FRAM), and MRAM, and other semiconductor elements capable of storing information. Sec, also, 3D XPoint (3DXP)) memories. Each type of memory device may have different configurations. For example, flash memory devices may be configured in a NAND or a NOR configuration.

In addition to data storage devices, the NVM arrays (and associated circuitry and latches, where appropriate) in various described embodiments may be implemented as part of memory devices such as dual in-line memory modules (DIMMs) or other types of memory components/modules in some embodiments. Such memory devices may be accessible to a processing component such as a Central Processing Unit (CPU) or a Graphical Processing Unit (GPU). The links between processing components to such memory devices may be provided via one or more memory or system buses, including via interconnects such as Compute Express Link (CXL), Gen-Z, OpenCAPI, NVLink/NVSwitch, Infinity Fabric, Omni-Path, and other similar interconnect protocols. In other embodiments, the links between processing components to memory devices may be provided via on-die or die-to-die interconnects. In certain embodiments, the NVM arrays and associated circuitry may be co-located on the same die as the processing components such as CPU or GPU. In other examples, data may be stored in as hard disk drives (HDDs) or hybrid drives, etc.

Regarding the application of the features described herein to other memories besides NAND: NOR, 3DXP, PCM, and ReRAM have page-based architectures and programming processes that usually require operations such as shifts, XORs, ANDs, etc. If such devices do not already have latches (or their equivalents), latches can be added to support the latch-based operations described herein. Note also that latches can have a small footprint relative to the size of a memory array as one latch can connect to many thousands of cells, and hence adding latches does not typically require much circuit space.

The memory devices can be formed from passive and/or active elements, in any combination. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bitline and accessed as a group. Alternatively, memory elements may be configured so that each element is individually accessible, e.g., a NOR memory array. NAND and NOR memory configurations are exemplary, and memory elements may be otherwise configured. The semiconductor memory elements located within and/or over a substrate may be arranged in two or three dimensions, such as a two-dimensional memory structure or a three-dimensional memory structure.

In a two-dimensional memory structure, the semiconductor memory elements are arranged in a single plane or a single memory device level. Typically, in a two-dimensional memory structure, memory elements are arranged in a plane (e.g., in an x-y direction plane) which extends substantially parallel to a major surface of a substrate that supports the memory elements. The substrate may be a wafer over or in which the layer of the memory elements is formed or it may be a carrier substrate that is attached to the memory elements after they are formed. As a non-limiting example, the substrate may include a semiconductor such as silicon. The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bitlines and word lines.

A three-dimensional memory array is arranged so that memory elements occupy multiple planes or multiple memory device levels, thereby forming a structure in three dimensions (i.e., in the x, y and z directions, where the z direction is substantially perpendicular and the x and y directions are substantially parallel to the major surface of the substrate). As a non-limiting example, a three-dimensional memory structure may be vertically arranged as a stack of multiple two-dimensional memory device levels. As another non-limiting example, a three-dimensional memory array may be arranged as multiple vertical columns (e.g., columns extending substantially perpendicular to the major surface of the substrate, i.e., in the z direction) with each column having multiple memory elements in each column. The columns may be arranged in a two-dimensional configuration, e.g., in an x-y plane, resulting in a three-dimensional arrangement of memory elements with elements on multiple vertically stacked memory planes. Other configurations of memory elements in three dimensions can also constitute a three-dimensional memory array.

By way of a non-limiting example, in a three-dimensional NAND memory array, the memory elements may be coupled together to form a NAND string within a single horizontal (e.g., x-y) memory device level. Alternatively, the memory elements may be coupled together to form a vertical NAND string that traverses across multiple horizontal memory device levels. Other three-dimensional configurations can be envisioned wherein some NAND strings contain memory elements in a single memory level while other strings contain memory elements that span through multiple memory levels. Three-dimensional memory arrays may also be designed in a NOR configuration and a ReRAM configuration.

Typically, in a monolithic three-dimensional memory array, one or more memory device levels are formed above a single substrate. Optionally, the monolithic three-dimensional memory array may also have one or more memory layers at least partially within the single substrate. As a non-limiting example, the substrate may include a semiconductor such as silicon. In a monolithic three-dimensional array, the layers constituting each memory device level of the array are typically formed on the layers of the underlying memory device levels of the array. However, layers of adjacent memory device levels of a monolithic three-dimensional memory array may be shared or have intervening layers between memory device levels.

Then again, two-dimensional arrays may be formed separately and then packaged together to form a non-monolithic memory device that has multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three-dimensional memory arrays. Further, multiple two-dimensional memory arrays or three-dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements. One of skill in the art will recognize that the subject matter described herein is not limited to the two-dimensional and three-dimensional exemplary structures described but covers all relevant memory structures within the spirit and scope of the subject matter as described herein and as understood by one of skill in the art.

The examples set forth herein are provided to illustrate certain concepts of the disclosure. The apparatus, devices, or components illustrated above may be configured to perform one or more of the methods, features, or steps described herein. Those of ordinary skill in the art will comprehend that these are merely illustrative, and other examples may fall within the scope of the disclosure and the appended claims. Based on the teachings herein those skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

Aspects of the present disclosure have been described above with reference to schematic flowchart diagrams and/or schematic block diagrams of methods, apparatus, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

The subject matter described herein may be implemented in hardware, software, firmware, or any combination thereof. As such, the terms “function,” “module,” and the like as used herein may refer to hardware, which may also include software and/or firmware components, for implementing the feature being described. In one example implementation, the subject matter described herein may be implemented using a computer-readable medium having stored thereon computer-executable instructions that when executed by a computer (e.g., a processor) control the computer to perform the functionality described herein. Examples of computer-readable media suitable for implementing the subject matter described herein include non-transitory computer-readable media, such as disk memory devices, chip memory devices, programmable logic devices, and application-specific integrated circuits. In addition, a computer-readable medium that implements the subject matter described herein may be located on a single device or computing platform or may be distributed across multiple devices or computing platforms.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

The various features and processes described above may be used independently of one another, or may be combined in various ways. All possible combinations and sub-combinations are intended to fall within the scope of this disclosure. In addition, certain method, event, state or process blocks may be omitted in some implementations. The methods and processes described herein are also not limited to any particular sequence, and the blocks or states relating thereto can be performed in other sequences that are appropriate. For example, described tasks or events may be performed in an order other than that specifically disclosed, or multiple may be combined in a single block or state. The example tasks or events may be performed in serial, in parallel, or in some other suitable manner. Tasks or events may be added to or removed from the disclosed example embodiments. The example systems and components described herein may be configured differently than described. For example, elements may be added to, removed from, or rearranged compared to the disclosed example embodiments.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage or mode of operation.

While the above descriptions contain many specific embodiments of the invention, these should not be construed as limitations on the scope of the invention, but rather as examples of specific embodiments thereof. Accordingly, the scope of the invention should be determined not by the embodiments illustrated, but by the appended claims and their equivalents. Moreover, reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise.

The terminology used herein is for the purpose of describing particular aspects only and is not intended to be limiting of the aspects. As used herein, the singular forms “a,” “an” and “the” are intended to include the plural forms as well (i.e., one or more), unless the context clearly indicates otherwise. An enumerated listing of items does not imply that any or all of the items are mutually exclusive and/or mutually inclusive, unless expressly specified otherwise. It will be further understood that the terms “comprises,” “comprising,” “includes” “including,” “having,” and variations thereof when used herein mean “including but not limited to” unless expressly specified otherwise. That is, these terms may specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “cither” and “both” and is not limited to “exclusive or” (“XOR”), unless expressly stated otherwise. It is also understood that the symbol “/” between two adjacent words has the same meaning as “or” unless expressly stated otherwise. Moreover, phrases such as “connected to,” “coupled to” or “in communication with” are not limited to direct connections unless expressly stated otherwise.

Any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be used there or that the first element must precede the second element in some manner. Also, unless stated otherwise a set of elements may include one or more elements. In addition, terminology of the form “at least one of A, B, or C” or “A, B, C, or any combination thereof” used in the description or the claims means “A or B or C or any combination of these elements.” For example, this terminology may include A, or B, or C, or A and B, or A and C, or A and B and C, or 2A, or 2B, or 2C, or 2A and B, and so on. As a further example, “at least one of: A, B, or C” is intended to cover A, B, C, A-B, A-C, B-C, and A-B-C, as well as multiples of the same members (e.g., any lists that include AA, BB, or CC). Likewise, “at least one of: A, B, and C” is intended to cover A, B, C, A-B, A-C, B-C, and A-B-C, as well as multiples of the same members. Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

As used herein, the term “determining” encompasses a wide variety of actions. For example, “determining” may include calculating, computing, processing, deriving, investigating, looking up (e.g., looking up in a table, a database, datastore, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

What is claimed is:

1. A data storage device, comprising:
a first data storage controller coupled to a first memory, the first memory comprising one or more memory dies of a first quality grade;
a second data storage controller coupled to a second memory, the second memory comprising one or more memory dies of a second quality grade that is lower than the first quality grade;
a multiplexer coupled to the first data storage controller and the second data storage controller; and
a connector coupled to the multiplexer and configured to connect the multiplexer to a host;
wherein, based on a memory selection signal, the multiplexer is configured to (a) connect the first data storage controller and the first memory to the host through the multiplexer or (b) connect the second data storage controller and the second memory to the host through the multiplexer.

2. The data storage device of claim 1,
wherein the first data storage controller is configured to send a signal to the second data storage controller to deactivate the second data storage controller while the first data storage controller is connected to the host though the multiplexer; and
wherein the second data storage controller is configured to send a signal to the first data storage controller to deactivate the first data storage controller while the second data storage controller is connected to the host though the multiplexer.

3. The data storage device of claim 1, wherein the multiplexer is configured to receive the memory selection signal from one of the first and second data storage controllers.

4. The data storage device of claim 1, further comprising a user control switch on an external housing of the data storage device, and wherein the multiplexer is configured to receive the memory selection signal from the user control switch.

5. The data storage device of claim 1, wherein the first quality grade is a prime quality grade and the second quality grade is less than the prime quality grade.

6. The data storage device of claim 5, wherein the second quality grade is an archival quality grade.

7. The data storage device of claim 1, wherein the connector is compatible with Universal Serial Bus (USB) Type C specifications.

8. The data storage device of claim 1, wherein the one or more memory dies of the first quality grade and the one or more memory dies of the second quality grade may comprise one or more NAND dies and one or more volatile memory dies.

9. A data storage device, comprising:
a first data storage controller coupled to a first memory, the first memory comprising NAND;
a second data storage controller coupled to a second memory, the second memory comprising a magnetic storage device;
a multiplexer coupled to the first data storage controller and the second data storage controller; and
a connector coupled to the multiplexer and configured to connect the multiplexer to a host;
wherein, based on a memory selection signal, the multiplexer is configured to (a) connect the first data storage controller and the first memory to the host through the multiplexer or (b) connect the second data storage controller and the second memory to the host through the multiplexer.

10. The data storage device of claim 9,
wherein the first data storage controller is configured to send a signal to the second data storage controller to deactivate the second data storage controller while the first data storage controller is connected to the host through the multiplexer; and
wherein the second data storage controller is configured to send a signal to the first data storage controller to deactivate the first data storage controller while the second data storage controller is connected to the host through the multiplexer.

11. The data storage device of claim 9, wherein the multiplexer is configured to receive the memory selection signal from one of the first and second data storage controllers.

12. The data storage device of claim 9, further comprising a user control switch on an external housing of the data storage device, and wherein the multiplexer is configured to receive the memory selection signal from the user control switch.

13. The data storage device of claim 9, wherein the connector is a Universal Serial Bus (USB) connector, the magnetic storage device is a Serial Advanced Technology Attachment (SATA) hard disk drive (HDD), and the second data storage controller comprises a USB-to-SATA bridge.

14. The data storage device of claim 9, wherein the first memory comprises a NAND die having a prime quality grade.

15. A data storage device, comprising:
a first data storage controller coupled to a first memory;
a second data storage controller coupled to a second memory;
a connector configured to connect the data storage device to a host using a first communication lane and a second communication lane, with communications over the first communication lane configured in accordance with a first communication protocol and with concurrent communications over the second communication lane configured in accordance with a second, different communication protocol; and
a lane control switch configured to (a) connect the first data storage controller to the host via the connector using the first communication lane while the second data storage controller is concurrently connected to the host via the connector using the second communication lane or (b) connect the first data storage controller to the host via the connector using the second communication lane while the second data storage controller is concurrently connected to the host via the connector using the first communication lane.

16. The data storage device of claim 15, further comprising a user control switch on an external housing of the data storage device that is configured to send a signal to the lane control switch to control the lane control switch.

17. The data storage device of claim 15, wherein the lane control switch is configured to receive a signal from the host that controls the lane control switch.

18. The data storage device of claim 15, wherein the first communication protocol is Universal Serial Bus (USB) 10 Gbps or higher and the second communication protocol is USB 2.0.

19. The data storage device of claim 15, further comprising indicia on the data storage device and on an external connection cable that mates with the connector in one of two mating orientations, with the indicia configured to indicate a particular mating orientation of the external connection cable within the connector of the data storage device.

20. The data storage device of claim 19, wherein the indicia comprise colors that match while the external connection cable is connected to the connector in a first mating orientation but which do not match while the external connection cable is connected to the connector in a second mating orientation.
